(19) United States
(12) Patent Application Publication
(10) Pub. No.: US 2025/0296853 A1
(43) Pub. Date: Sep. 25, 2025

(54) FLUID DECONTAMINATION APPARATUS

(71) Applicant: Pontic Technology, LLC, Seal Beach, CA (US)

(72) Inventor: Gerald Voecks, La Crescenta, CA (US)

(21) Appl. No.: 19/231,309

(22) Filed: Jun. 6, 2025

Related U.S. Application Data
(63) Continuation-in-part of application No. 18/635,847, filed on Apr. 15, 2024, now Pat. No. 12,344,535.
Application No. 18/635,847 is a continuation of application No. 16/912,151, filed on Jun. 25, 2020, now Pat. No. 12,129,186.
Application No. 16/912,151 is a continuation of application No. 16/192,745, filed on Nov. 15, 2018, now Pat. No. 10,710,897.
(60) Provisional application No. 62/587,043, filed on Nov. 16, 2017.
(60) Provisional application No. 62/641,677, filed on Mar. 12, 2018.

(51) Int. Cl. C02F 1/00; B01D 46/00; B01F 25/452; C02F 1/32; C02F 1/36; C02F 1/72; C02F 101/30

(52) U.S. Cl. CPC C02F 1/001; B01D 46/0002; B01D 46/0054; C02F 1/325; C02F 1/36; C02F 1/725; B01F 25/4524; C02F 2101/30; C02F 2201/002; C02F 2201/3227; C02F 2301/02; C02F 2301/06; C02F 2301/10

(57) ABSTRACT

A fluid decontamination apparatus is provided for, introducing, via an inlet nozzle, a contaminated fluid from a fluid source into a continuous pipe section. The inlet nozzle is coupled to the continuous pipe section that enables fluid flow therethrough. Hydrodynamic cavitation is generated upon exiting the inlet nozzle within the continuous pipe section by spraying the fluid that induces cavitation formation within the fluid across at least one three dimensionally open structured (3DOS) element disposed within the continuous pipe section. The 3DOS element may be sequentially arranged foam rings defining an inner flow channel, or may be one or more solitary structures. The 3DOS structure is positioned such that the hydrodynamic cavitation generated by the inlet nozzle enters the 3DOS element, which maintains the hydrodynamic cavitation to enable destruction of toxic species and unwanted organic compounds contained in the contaminated fluid.

### CROSS REFERENCE TO RELATED APPLICATION

This application is a continuation-in-part application of U.S. patent application Ser. No. 18/635,847, filed Apr. 15, 2024, which is a continuation application of U.S. patent application Ser. No. 16/912,151, filed Jun. 25, 2020, which is a continuation application of U.S. patent application Ser. No. 16/192,745, filed Nov. 15, 2018, which claims the benefit of U.S. Provisional App. No. 62/587,043, filed Nov. 16, 2017, and U.S. Provisional App. No. 62/641,677, filed Mar. 12, 2018, all of which are incorporated by reference.

### FIELD OF THE INVENTION

The present invention relates generally to fluid decontamination and, more particularly, to the use of three dimensionally open structured material to enhance existing fluid decontamination methods.

### BACKGROUND OF THE INVENTION

Fluids, particularly liquids such as water, are susceptible to being contaminated with toxic species and other unwanted organic compounds. As such, there are several methods used in various industries to decontaminate and treat such contaminated fluids. These methods include sonication, hydrodynamic cavitation and/or the use of chemical reactions, particularly aided with a catalyst.

However, several of these existing methods are often limited in their effectiveness due to physical and/or spatial constraints. For example, hydrodynamic cavitation, which relies on the increase in fluid flow turbulence and occurrence of cavitation, or gas voids/bubbles, is often limited to decontaminating the specific localized areas where cavitation occurs. Thus, a significant portion of the fluid flow would need to be exposed to cavitation in order for effective decontamination to occur. Another example is the use of catalysts to initiate chemical reactions that destroy or modify such unwanted chemicals to render them safe. Often, a single or uniform type of catalyst is employed which may only be effective in targeting a fraction of the unwanted compounds.

It should therefore, be appreciated that there remains a need for effectively decontaminating liquids, including enhancing existing decontamination methods to improve the destruction of toxic species and other unwanted organic compounds. The present invention addresses this need and others.

### SUMMARY OF THE INVENTION

Briefly, and in general terms, the invention provides a fluid decontamination apparatus that contains one or more three dimensionally open structured (3DOS) substrates to facilitate the destruction of toxic species and unwanted organic compounds contained in a contaminated fluid. The apparatus may include a body configured to introduce the contaminated fluid through one or more nozzles configured to induce turbulent flow, wherein the contaminated fluid contacts the one or more 3DOS substrates as it flows across the body prior to being discharged via an outlet. The 3DOS substrates can be porous and permeable, wherein the porosity enables extending the volume of fluid flow exposed to flow turbulence, further inducing cavitation and thereby promoting the degradation and/or alteration of the toxic species and unwanted organic chemicals. The 3DOS substrates are also configured to initiate chemical reactions on its exterior and interior surfaces. As such, the 3DOS substrates provide a means for enhancing the destruction of toxic species and unwanted organic compounds contained in a contaminated fluid.

According to another aspect of the invention, a fluid decontamination apparatus is provided, including a continuous pipe section that enables fluid flow therethrough, the continuous pipe section having opposing ends; an inlet nozzle coupled to a contaminated fluid source and coupled to the continuous pipe section coupled to a first opposing end of the continuous pipe section and having a nozzle opening oriented aligned with the fluid flow direction for introducing a fluid flow into the continuous pipe section, said nozzle configured to spray the fluid into the continuous pipe section to induce cavitation formation within the fluid; at least one three-dimensionally open structured (3DOS) element disposed within the continuous pipe section and structured such that the hydrodynamic cavitation extends through the at least one 3DOS element to enable destruction of toxic species and unwanted organic compounds contained in the contaminated fluid; and an outlet at a second opposing end of the continuous pipe section that is opposite said first opposing end of the continuous pipe section.

In a detailed aspect of an exemplary embodiment, one or more inlet apertures are disposed about the body, wherein a corresponding nozzle can be inserted and secured within each of the said inlet apertures. Each nozzle is configured to spray the contaminated fluid in a manner that induces turbulent flow while being directed to impinge onto the interior and/or exterior surfaces of a respective 3DOS substrate. The nozzles can have nozzle openings oriented in any direction, such as parallel or orthogonal to the fluid flow through a 3DOS substrate, wherein the contaminated fluid is sprayed though said nozzle openings. The nozzles may also be of different configurations, orientations, size, and may also vary in number and location, so as to vary the spray projection as directed to the 3DOS substrates and optimize the decontamination of the contaminated fluid.

More specifically, in an exemplary embodiment, the 3DOS substrates can be composed of a metal alloy, such as FeCrAl, also known as fecralloy that includes the Kanthal® brand. The metal alloy can be configured as a metal foam or configured with similar characteristics as metal foam, such as high elasticity, tensile strength, and heat resistance. Such characteristics can also vary depending on any other fluid decontamination measures utilized. The 3DOS substrates can also be configured with prescribed levels of porosity, permeability, and tortuosity as a function of open pore sizes ranging from microns to millimeters, including open-ended and closed-ended pores, as seen with common metal and ceramic foams, wire meshes, and other reticulated material. The porosity can define a fluid flow path (flow pattern) within the 3DOS substrate that enables extending the volume of a fluid experiencing turbulent flow conditions, and thus increasing the exposure to hydrodynamic cavitation within the fluid, leading to further destruction of unwanted and toxic chemicals. The 3DOS substrates further provide active sites on its exterior and/or interior surfaces wherein chemical reactions can proceed, also leading to the destruction of unwanted and toxic chemicals. The 3DOS substrates can also be configured in a plurality of shapes and sizes, including a cylinder and/or conical-end cylinder, or in sheets shaped to accommodate the fluid flow from the nozzles.

In a detailed aspect of an exemplary embodiment, the 3DOS substrate can be configured as a metal foam with surfaces that are chemically modified to enable and enhance chemical reactions to take place on said surfaces, which will assist in the chemical destruction of the toxic chemicals in the fluid stream. Additionally, the foam material may be composed of any non-metallic materials, such as, but not limited to, ceramics, such as aluminum or silicon oxides, and may be reticulated carbon or quartz in open pore structures. Moreover, the surfaces of the substrates may be modified to specifically trap and remove toxic chemical species, as a result of chemical or physical interaction between the toxic species and the nature of the modified surface.

In another detailed aspect of an exemplary embodiment, the 3DOS substrates can be coated with catalysts to enhance the ability to initiate chemical reactions on its external and/or internal surfaces. Moreover, the 3DOS substrates can contain a selective catalyst system, where various types of catalysts are coated at different portions of a 3DOS substrate to promote and accelerate different chemical reactions that destroy or alter specific contaminants of a fluid. Furthermore, a 3DOS substrate coated with a catalyst at the inlet of the substrate, followed by a surface coated with material to enable absorption and/or adsorption of specific chemicals will maximize the removal of unwanted contaminants.

In yet another detailed aspect of an exemplary embodiment, the fluid decontamination apparatus can include a plurality of separate decontamination bodies that are sequentially coupled to each other, with each decontamination body comprising 1) an inlet nozzle configured to induce hydrodynamic cavitation, and 2) a 3DOS substrate section. As such, the volume of a contaminated fluid that is exposed to cavitation forming conditions is increased as the fluid flows through each decontamination body sequentially.

In yet another detailed aspect of an exemplary embodiment, the 3DOS substrates can comprise corrugated and/or smooth metal strips that are wound with or without a mandrel, providing a similar effect as previously described with the use of a metal alloy with metal foam characteristics. The metal strips can include corrugated metal strips placed at different angles (such as chevron corrugations), perforated corrugated metal strips, and different lengths of metal strips.

In yet another detailed aspect of an exemplary embodiment, the 3DOS substrates can comprise wire mesh wound in a cylinder or placed as a packed bed within a container body, providing a similar effect as previously described with the use of a metal foam or corrugated metal strips.

In yet another detailed aspect of an exemplary embodiment, the fluid decontamination apparatus can be used with a UV spectral irradiation reactor chamber, wherein the fluid flows through the reactor chamber, and is targeted by UV lights from germicidal UV lights. The reactor chamber can be quartz walled to enable the UV light to impinge upon the contaminated fluid. Moreover, the 3DOS substrates can be made of quartz material to enable the UV light to continue to impinge upon the contaminated fluid. The 3DOS substrates can be a packed bed of quartz beads or particles, or a plurality of quartz particles fused onto a quartz support strut, wherein either method extends the volume that a fluid is exposed in turbulent flow conditions.

In yet another detailed aspect of an exemplary embodiment, the system can be configured to decontaminate the fluid as it flows therethrough in a continuous flow or in a pulse flow. Embodiments can include (1) continuous flow, (2) pulse flow, or (3) both continuous flow and pulse flow.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a side cutaway perspective view of a fluid decontamination apparatus in accordance with the present invention, depicting contaminated fluid entering a body through nozzles and contacting multiple 3DOS substrates.

FIG. 2 is a side cutaway perspective view of a fluid decontamination apparatus in accordance with the present invention, depicting nozzles spraying contaminated fluid into a body in different orientations and impinging onto a 3DOS substrate that has a conical head with a cylindrical body.

FIG. 3 is a side cutaway perspective view of a fluid decontamination apparatus in accordance with the present invention, depicting nozzles spraying contaminated fluid into a body in different orientations and impinging onto a 3DOS substrate that has a cylindrical body of uniform diameter.

FIG. 4 is a side cutaway perspective view of a fluid decontamination apparatus in accordance with the present invention, depicting contaminated fluid flowing through a piping system and contacting 3DOS substrates, wherein nozzles have nozzle openings oriented in a direction orthogonal to the fluid flow direction.

FIG. 5 depicts an open-cell foam structure with a random spatial configuration of the pores.

FIG. 6 depicts a 3DOS substrate embodied as a metal foam with an organized spatial configuration of the pores.

FIG. 7 depicts a fluid decontamination apparatus in accordance with the present invention, depicting an inlet section and 3DOS substrate section, and connected piping.

FIG. 8 depicts a fluid decontamination apparatus in accordance with the present invention, depicting a plurality of decontamination bodies arranged sequentially, each decontamination body including an inlet section and 3DOS substrate section.

FIG. 9 depicts a perforated corrugated metal strip that is attached to a mandrel when being wound.

FIG. 10 depicts corrugated metals strips wound in a cylindrical manner without a mandrel.

FIG. 11 depicts a perforated corrugated metal strip that can be combined in layers and wound with or without a mandrel.

FIG. 12 depicts a corrugated metal strip that can be combined in layers and wound with or without a mandrel.

FIG. 13 depicts a perforated corrugated metal strip, wherein the corrugations are aligned in an angled chevron manner, and such metals strips can be combined in layers, and wound with or without a mandrel.

FIG. 14 is a side cutaway perspective view of a UV reactor chamber for fluid decontamination, comprising an inlet orifice or venturi for spraying the contaminated fluid in a turbulent manner across a 3DOS substrate.

FIG. 15 is a side-cutaway view of the fluid decontamination apparatus of FIG. 14, depicting a 3DOS substrate comprising quartz particles attached to a quartz strut, with UV lamps disposed about the reactor chamber.

FIG. 16 is a side-cutaway view of the fluid decontamination apparatus of FIG. 14, depicting a 3DOS substrate comprising quartz particles or beads arranged in a packed bed manner, with germicidal UV lights disposed about the reactor chamber.

FIG. 17 depicts an optimal UV light wavelength in a spectrum for destroying unwanted biological compounds and species in a contaminated fluid.

FIG. 18 depicts a graphical representation of germicidal effectiveness against UV wavelength, indicating the peak effectiveness.

FIG. 19 is a depiction of fluid flow through a venturi nozzle, depicting cavitation bubble paths or trajectories overlapped over the resulting pressure contours.

FIG. 20 is a depiction of fluid flow through an orifice, depicting cavitation bubble paths or trajectories overlapped over the resultant pressure contours.

FIG. 21 depicts a schematic cross-sectional side view of a channel having sequentially arranged foam rings with variable inner diameters arranged at an offset from the orifice.

FIG. 22 depicts a schematic cross-sectional side view of a channel having sequentially arranged foam rings with variable inner diameters spaced apart from one another.

FIG. 23 depicts a schematic cross-sectional side view of a channel having sequentially arranged foam rings forming a uniformly expanding internal flow path.

FIG. 24 depicts a schematic cross-sectional side view of a channel having sequentially arranged foam rings of varying porosities forming a uniformly expanding internal flow path.

FIG. 25 depicts a schematic cross-sectional side view of a channel having sequentially arranged foam rings of varying porosities forming a uniformly expanding internal flow path, shown with catalyst material about the inner diameter of the foam rings.

FIG. 26 depicts a schematic cross-sectional side view of a channel having sequentially arranged segmented foam rings spaced apart from one another to create a uniformly expanding internal flow path.

FIG. 27A depicts a schematic cross-sectional side view of a channel having a uniformly expanding conical foam insert arranged at the orifice.

FIG. 27B depicts a schematic cross-sectional side view of a channel having a uniformly expanding conical foam insert arranged at the orifice, and including bypass gaps at its maximum diameter.

FIG. 28A depicts a schematic cross-sectional side view of a channel having a uniformly expanding elongated conical foam insert arranged at the orifice.

FIG. 28B depicts a schematic cross-sectional side view of a channel having a uniformly expanding elongated conical foam insert arranged at the orifice, and including bypass gaps at its maximum diameter.

FIG. 29 depicts a schematic cross-sectional side view of a channel having a bicone foam insert arranged at the orifice, and including bypass gaps at its maximum diameter.

FIG. 30 depicts a schematic cross-sectional side view of a channel having a cylindrical foam insert arranged at the orifice.

FIG. 31A depicts a front view of a fixture for holding a conical foam element within a channel, shown without a conical foam element attached.

FIG. 31B depicts a front view of a fixture for holding a conical foam element within a channel, shown with a conical foam element attached.

FIG. 31C depicts a side view of a fixture for holding a conical foam element within a channel, shown with a conical foam element attached.

FIG. 32A depicts a front view of a fixture for holding a cylindrical foam element within a channel, shown without a cylindrical foam element attached.

FIG. 32B depicts a front view of a fixture for holding a cylindrical foam element within a channel, shown with a cylindrical foam element attached.

FIG. 32C depicts a side view of a fixture for holding a cylindrical foam element within a channel, shown with a cylindrical foam element attached.

FIG. 33 depicts a schematic cross-sectional side view of a channel having sequentially arranged segmented foam elements spaced apart from one another and affixed in the channel by fixtures.

FIG. 34A depicts an axial view of an exemplary foam ring element.

FIG. 34B depicts a side view of an exemplary foam ring element.

FIG. 34C is a cross-sectional view taken along line A-A of FIG. 34A of the foam ring element having a uniform inner diameter.

FIG. 34D is a cross-sectional view taken along line A-A of FIG. 34A of the foam ring element having a tapered inner diameter.

### DETAILED DESCRIPTION OF THE PREFERRED EMBODIMENTS

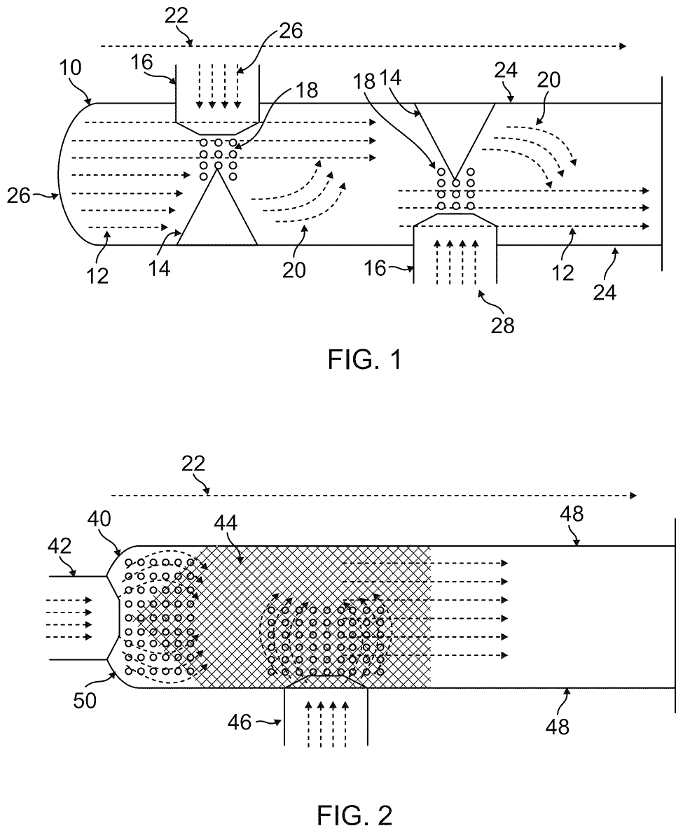

Referring now to the drawings, and particularly FIG. 1, there is shown a fluid decontamination apparatus having a body 10 with a plurality of three-dimensional open structure (3DOS) substrates 14 spaced about therein, wherein a contaminated fluid flowing 12 through the body 10 will contact the 3DOS substrates 14. Nozzles 16 can be inserted and secured within inlet apertures disposed about the body 10 and configured to inject 28 the contaminated fluid with/without air to induce the occurrence of hydrodynamic cavitation 18. The substrates 14 can be porous and permeable, enabling the contaminated fluid to flow 12 therethrough, wherein the fluid flow passageway through the pores extends the volume of contaminated fluid exposed to turbulent and cavitation inducing flow conditions. Moreover, the 3DOS substrates 14 may be coated with one or more types of catalysts, wherein the interaction between the contaminated fluid and the porous surfaces can initiate chemical reactions. As such, the extended exposure of the contaminated fluid to the formation and implosion of gaseous voids from hydrodynamic cavitation, along with the chemical reactions carried out on the porous surfaces, enable an increased number of toxic species and unwanted organic compounds to be destroyed and/or altered, thereby enhancing the decontamination of the flowing fluid 12.

With reference to FIGS. 1-3, the exemplary embodiments depict a body (10, 40), defining an enclosure that receives the contaminated fluid through one or more nozzles (16, 42, 46), which are inserted and secured within inlet apertures disposed about the respective body. Each nozzle defines a fluid flow passageway between the body (10, 40) and an external fluid source, such as a piping system. The contaminated fluid flows through the body (10, 40), with at least a portion of the fluid flowing through one or more three-dimensional open-structured substrates (14, 44, 52), prior to exiting the body through one or more outlets (e.g. FIG. 7 reference character 207). The net displacement of the fluid flow is in a direction parallel to a longitudinal axis (Ax) 22 of the body (10, 40). Each nozzle can be configured to spray the contaminated fluid in a uniform manner. In addition or alternatively, the actual fluid flow profile may also be non-uniform due to its turbulence.

In an exemplary embodiment, the fluid flow displacement is based on the location of the inlet aperture(s) (16, 42, 46) and outlet aperture(s) (not shown), wherein the fluid will flow from the inlet apertures to the outlet apertures. In addition, or alternatively, the flow of the contaminated fluid within the body can be continuous and/or pulsated flow. Furthermore, in addition or alternative embodiments, the inlet aperture(s) can be aligned or inserted with other means for receiving fluid, such as other types of pipe fittings. The body (10, 40) can include a longitudinal section (24, 48) that is parallel with the longitudinal axis 22 (Ax), and the body can further include opposing ends comprising of a first end (26, 50) and a second end (not shown). The body can be configured as a tubular shape, or any another shape.

Referring now to FIG. 1, the contaminated fluid is introduced within the body via injection nozzles 16 (inserted within a respective inlet aperture) that are disposed about the longitudinal section 24 of the container body 10. Each injection nozzle 16 comprises a nozzle opening that is oriented orthogonal to the longitudinal axis 22, and thereby configured to spray the contaminated fluid orthogonal to the fluid flow through 3DOS substrates 14 and the container body 10. Exemplary conditions for the fluid introduced within the container body include pressures ranging from 0.2 MPa to 0.55 MPa for a water flow rate between 3.5 liters/min to 5.0 liters/min.

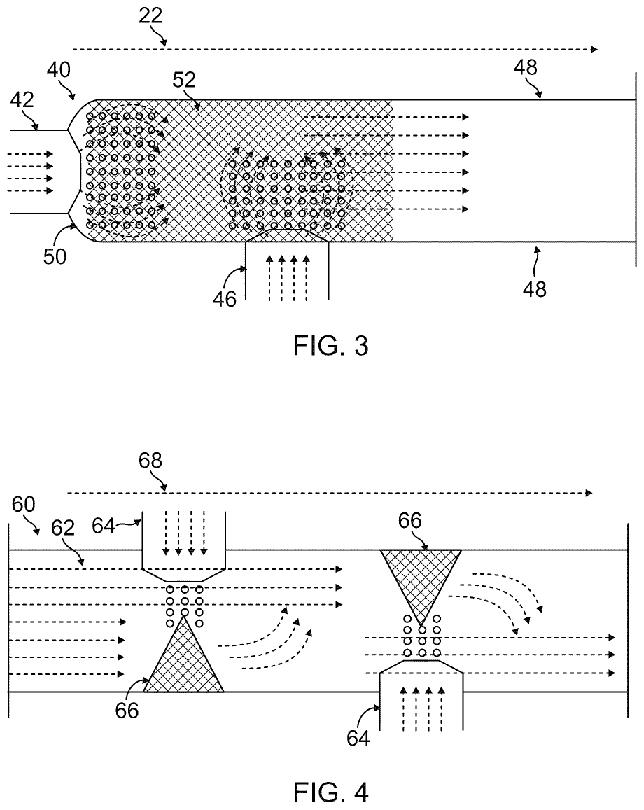

By contrast, referring now to FIGS. 2 and 3, the body 40 includes a parallel spraying injection nozzle 42 disposed at one of the opposing sides 50, and an orthogonal spraying injection nozzle 46 disposed on the longitudinal section 48, wherein the 3DOS substrate(s) (44, 52) covers the cross-section of the body 40 and fluid passageway for a specified length across the respective longitudinal section 48. The 3DOS substrate in FIG. 2 (44) comprises a conical inlet portion, while the 3DOS substrate depicted in FIG. 3 (52) is a cylinder with a uniform diameter. The number and location of nozzles for either body (10, 40) can be varied so as to spray fluid towards and impinging upon the respective 3DOS substrate(s) in a manner that optimally decontaminates the contaminated fluid (further described below).

Moreover, the nozzle type and size can vary for each inlet aperture (16, 42, 46), thereby impacting the performance of a 3DOS substrate in decontaminating fluid. For example, Venturi nozzles can be used to promote fluid to be injected/dispersed with increased turbulence. Each nozzle can include a nozzle opening that can be slit, conical, or a similar shape such that the spray pattern can be altered, thereby impacting the fluid flow turbulence. As aforementioned, each nozzle opening can be structured such that the flow pattern of a fluid will be directed to a 3DOS substrate, enabling the fluid flow to impinge onto the exterior and/or interior surfaces of the 3DOS substrates, described further below. Moreover, each nozzle opening can be configured to spray the contaminated fluid such that it interacts uniformly over the inlet section of a respective 3DOS substrate. It should be appreciated that a given fluid decontamination apparatus may contain various combinations of such nozzle sizes, orientation, and inlet structures, in addition to any combination of the number and location of such nozzles, without departing from the invention.

Referring now to FIG. 4, in an alternate embodiment, a decontamination assembly can be included within a pipe section of a continuous pipe 60 with contaminated fluid flowing 62 within, with the pipe 60 defining a fluid flow path parallel with a longitudinal axis (Ay) 68. The decontamination assembly includes one or more 3DOS substrates 66 and inlets 64 configured with injection nozzles for increasing fluid turbulence, which can include injecting contaminated fluid and/or air at medium or high pressure.

With continued reference to FIGS. 1-4, the 3DOS substrate(s) (14, 44, 52, 66) can be composed of a rigid, porous material, wherein liquid interaction with the 3DOS substrate is increased based on the porosity. The open structure is a function of the void volume in the substrate, i.e., the total volume of void space occupied in a 3DOS substrate. In the exemplary embodiment, the 3DOS substrate is comprised of a metal alloy, such as FeCrAl, which is commercially available, e.g., under the Kanthal® brand. The metal alloy can be configured as a metal foam (e.g., metal sponge), or exhibit similar characteristics as seen in metal foams, such as high porosity, elasticity, tensile strength, and good heat resistance. In addition to or alternatively, the 3DOS substrate can be configured with a ceramic foam. Characteristics such as porosity, permeability, and tortuosity can be configured as a function of open pore sizes ranging from 5 microns to 5millimeters. Moreover, the characteristics of a 3DOS substrate, including porosity, can be varied about the substrate, such as across its length, e.g., from inlet to exit.

In an alternate or additional embodiment, the foam material may be composed of any non-metallic materials, such as, but not limited to, ceramics, such as aluminum or silicon oxides, and/or may be reticulated carbon or quartz in open pore structures.

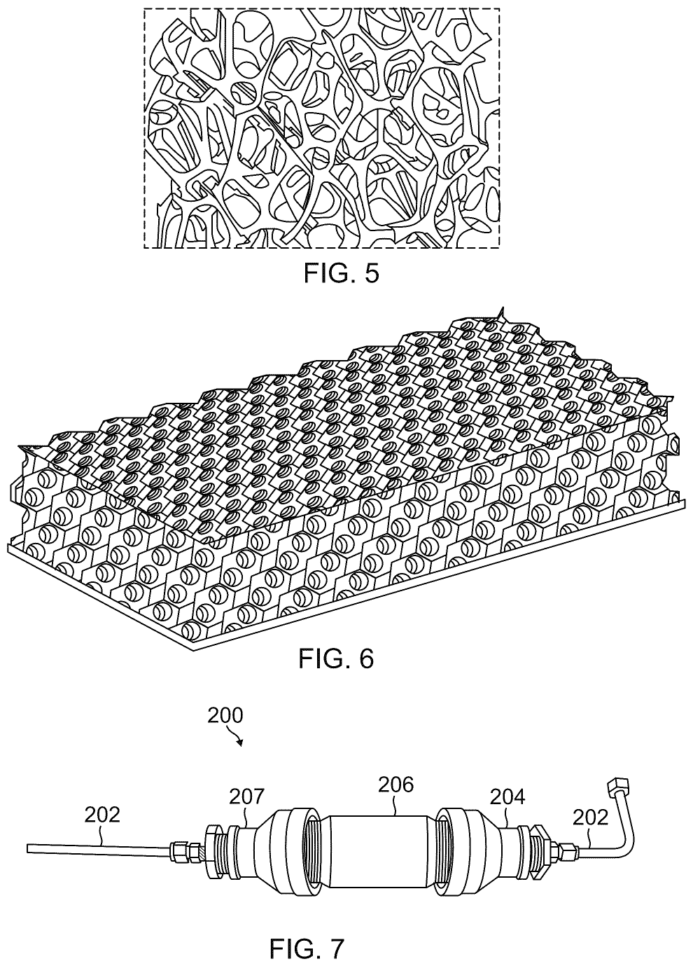

In an exemplary embodiment, the 3DOS substrate can employ open-cell pores, which consists of an interconnected network of pores within the metal body, enabling fluid to pass within and through said 3DOS substrate. In addition or alternatively, the cells may be partially obstructed, but not completely closed, thereby still enabling fluid to flow therein. Moreover, the cells may be disposed randomly within the 3DOS substrate (FIG. 5), or in an organized configuration (FIG. 6). The foam cells may include openness ranging from nominally 10 pores per inch (ppi) to 50 ppi, but may be as high as 100 ppi, depending on the choice of foam material and the inlet operating pressure. Furthermore, an exemplary range for the relative density of metal foams can be between 2% and 15% of the metal density making up the 3DOS structure. Metal oxide foam structures can be employed over a similar range for the relative ppi and density. Other exemplary ranges for relative density can include ceramic foams, ranging between 3% and 20%, and carbon foams, ranging between 3% and 4%. The relative density is the density of the of the 3DOS structure (with the specified porosity) divided by the density of the solid material making up the 3DOS structure (i.e. no pores). The porosity of a 3DOS structure can be determined based on the relative density.

The 3DOS structures may be further configured with open cell structures of varying shapes, from triangular to circular, thereby providing a means to control and/or direct the flow patterns through said 3DOS substrates that will enhance the ability to manifest the inlet hydrodynamic cavitation. As such, the contaminated fluid, in turbulent flow and incurring hydrodynamic cavitation formation, can be configured to pass through and exit the 3DOS substrate in a manner that extends the hydrodynamic cavitation throughout the 3DOS structure, due to the fluid flow patterns defined by the open structure within the 3DOS substrate. Thus, additional areas of reduced pressure are formed, further inducing hydrodynamic cavitation within the fluid to occur (described below). Moreover, the fluid flow pathways (patterns) within the 3DOS substrate increases the interaction between the fluid and substrate exterior and/or interior surfaces, thereby promoting chemical reactions and/or absorption/adsorption to occur on said exterior and/or interior surfaces (described below). As aforementioned, the interconnecting network of pores or reticulation can further be constructed with varying tortuosity and permeability, thereby affecting the length and extent of exposure of a contaminated fluid to the pores within a 3DOS substrate, which can be manipulated to enhance interaction with the substrate surfaces.

The 3DOS substrates can be of different shapes, sizes, and void fraction to enhance interaction between the contaminated fluid and substrate surfaces, and extend exposure of the fluid to turbulent and/or hydrodynamic inducing conditions. As aforementioned, the pore sizes for the 3DOS substrates may vary from microns to millimeters, wherein the specified size is based on the fluid velocity, viscosity, and inlet pressure of the fluid causing hydrodynamic cavitation at the inlet of the body. As aforementioned, exemplary inlet flow conditions can include 0.2 MPa to 0.55 MPa for a water flow rate between 3.5 liters/min to 5.0 liters/min, and the viscosity of a contaminated fluid can be similar to that of water (1 cP at 20° C.). The wall thickness of the 3DOS substrate can be defined based on the specified pores per inch (ppi) and density of the interconnecting pores, wherein such specifications also impact the size and porosity (void fraction) of a given substrate. Moreover, the porosity of a given 3DOS substrate can vary across its length, such as increasing, decreasing or varying non-uniformly across the 3DOS substrate, so as to manipulate the degree of turbulence and/or number of active sites for chemical reactions to proceed thereon, e.g., increasing the turbulence and number of active sites. Such varying porosity can be accomplished by varying the cell configuration and foam compositions, which can be manufactured by different methods, thereby introducing variations in pore size range and relative densities.

As aforementioned, the structure of the 3DOS substrate can be a cylinder with a uniform diameter, as seen in FIG. 3 (52). As another example, the structure of 3DOS substrate can be conical on one end, as seen in FIGS. 1, 2, and 4 (14, 44, 66). The reactor (body) could also contain sheets of the 3DOS substrate if a body (reactor) design other than cylindrical were employed. It should be appreciated that the structure of the 3DOS substrate can be in any shape that promotes hydrodynamic cavitation and fluid flow turbulence supporting decontamination. Moreover, the 3DOS substrate can be configured to limit the backpressure developed for the fluid flowing therethrough, so as to ensure there remains a minimum driving force (pressure differential) for 1) the fluid to flow at a certain flow rate and 2) to induce formation of hydrodynamic cavitation within the fluid.

As aforementioned, the 3DOS substrate can aid to extend the volume of fluid exposed to hydrodynamic cavitation formation conditions. Hydrodynamic cavitation is the formation, growth, and subsequent collapse of microbubbles in a fluid that results in a large amount of energy released per volume within milliseconds. The formation of such microbubbles, or gas voids, within a fluid, can be induced by a localized reduced pressure point. With reference to the 3DOS substrate, the combined action of the velocity of the fluid over the substrate walls within the 3DOS substrate results in a pressure drop on the downstream side of said walls due to the drag of the fluid flow over the respective surface, thereby resulting in cavitation formation. The subsequent increase in surrounding pressure results in the implosion of such gas voids, (i.e. collapsed microbubbles) which can result in localized pressures and temperatures ranging (but not limited to) from 10 MPA to 500 MPa and 1000K to 10,000K respectively. As a result of the collapsed microbubble conditions, unique chemical reactions can take place that can alter and/or destroy toxic species and/or unwanted organic compounds. The chemical reactions can take place, in part, due to radicals formed from the fluid, e.g. water, and/or due to the trace chemicals dissolved in the fluid (e.g. water).

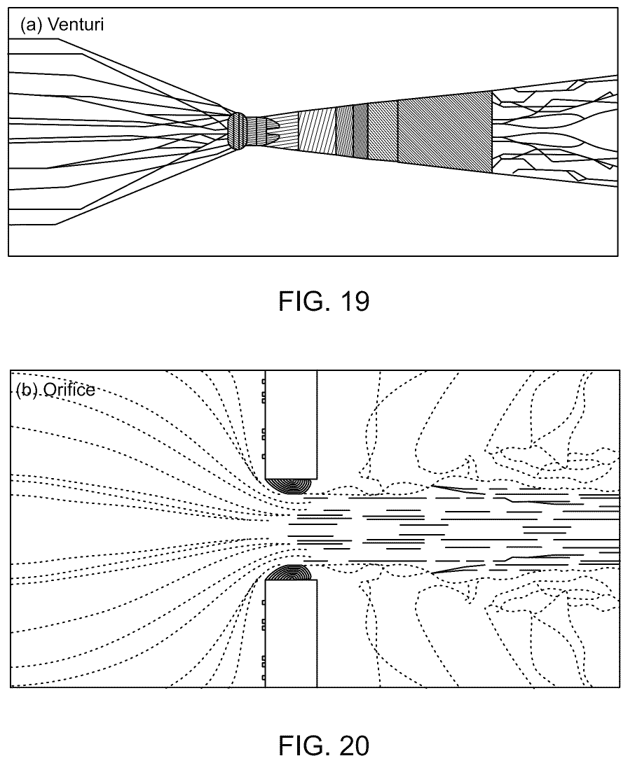

With reference to FIGS. 19 and 20, there is shown a depiction of the cavitation bubble paths or trajectories overlapped over the pressure contours in a venturi nozzle (FIG. 19) and through an orifice respectively (FIG. 20). As depicted in FIG. 19, fluid flow through a venturi nozzle results in a larger cross-sectional area exposed to a low-pressure region, whereas fluid flow through an orifice (FIG. 20) produces a low-pressure region about the orifice holes.

The effectiveness of decontaminating a fluid using hydrodynamic cavitation depends on the extent of fluid volume exposed to sufficiently turbulent conditions. As such, the use of a 3DOS substrate will extend the volume of fluid exposed to such turbulent conditions based on 1) the interconnected voids contained within the substrate and 2) the semi barrier that the 3DOS substrate as a whole presents to the fluid flow, thereby extending the cavitation forming conditions created by the inlet nozzle. Continued cavitation may also occur within the 3DOS substrate, depending on the flow velocity and the 3DOS substrate walls/structure within the flow path.

Referring now to FIG. 7, an exemplary decontamination apparatus 200 is depicted connected with a piping system 202 and configured to conduct experimental tests for evaluating the effectiveness of using 3DOS substrate(s) for fluid decontamination. The apparatus 200 comprises a 2″ inlet section 204 that includes a nozzle (not shown) configured to induce hydrodynamic cavitation within the fluid, and a larger 4″ section 206 that is configured to contain a 3DOS substrate within. The pipe 202 connected to the apparatus is ¼ inch. In the exemplary experimental tests, the fluid flowing through the pipe 202 and apparatus 200 is a water solution of four halogenated hydrocarbons. The water is introduced through the inlet nozzle 204 at a rate of 500 gpd and pressure of 0.00527 MPa. The experimental tests evaluated the decontamination of the water solution achieved by 1) using only hydrodynamic cavitation, induced by the inlet nozzle, wherein the fluid did not encounter a 3DOS substrate, and 2) inducing hydrodynamic cavitation and subsequently flowing the fluid through a 3DOS substrate section, which comprises of a FeCrAl foam structure with approximately 50 ppi. The results from the experimental test are below:

Hydrodynamic Cavitation Only (via
Nozzle) (Without 3DOS Substrate)

| | | Before | After |
|---|---|---|---|
| | | μg/L | μg/L |
| Bromodichloromethane | Lower Concentration | 150 | ND (non- |
| | | | detectable) |
| | Higher Concentration | 630 | 10 |
| Bromoform | Lower Concentration | 170 | 20 |
| | Higher Concentration | 680 | 77 |
| Chloroform | Lower Concentration | 130 | 81 |
| | Higher Concentration | 550 | 390 |
| Dibromochloromethane | Lower Concentration | 170 | 3 |
| | Higher Concentration | 700 | 14 |

Hydrodynamic Cavitation (via Nozzle) With 3DOS Substrate

| | | Before | After |
|---|---|---|---|
| | | μg/L | μg/L |
| Bromodichloromethane | Lower Concentration | 130 | ND |
| | Higher Concentration | 510 | ND |
| Bromoform | Lower Concentration | 130 | ND |
| | Higher Concentration | 520 | ND |
| Chloroform | Lower Concentration | 110 | 1.9 |
| | Higher Concentration | 430 | 17 |
| Dibromochloromethane | Lower Concentration | 140 | ND |
| | Higher Concentration | 590 | ND |

The test results indicate an increased reduction in contaminant concentration when inducing hydrodynamic cavitation within the fluid (via the inlet nozzle) and subsequently flowing the fluid through the 3DOS substrate section. Specifically, as seen in the test results, significant reduction in each halogenated contaminant results from the combined hydrodynamic cavitation and a Fecralloy foam that the hydrodynamic cavitation without the Fecralloy foam is incapable of producing. The contribution exhibited by the addition of the foam can be provided by any of several structures which have multiple voids or open spaces such as are found in reticulated shapes i.e., foams, or in perforated material, or in meshed material, through which fluids may flow with low pressure drop or similar pressure differential from inlet to exit and experience hydrodynamic cavitation as demonstrated in the above experiment. As such, the test results provide support for improved decontamination of fluids by extending the exposure of turbulence, and thereby cavitation formation, when flowing such fluids in turbulent flow and pressure differentials across one or more 3DOS substrates.

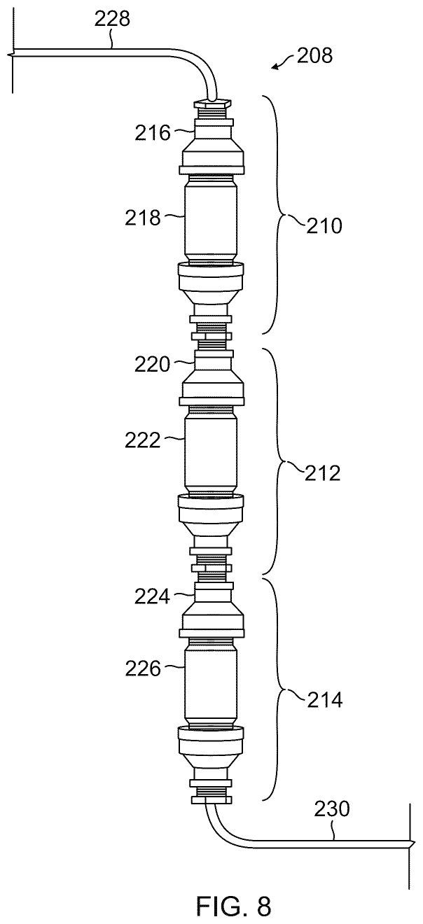

Referring now to FIG. 8, in an additional or alternate embodiment, a fluid decontamination apparatus 208 can comprise of a plurality of separate decontamination bodies (210, 212, 214) coupled to one another in a sequential manner. The first (210) and last (214) sequential bodies can be connected to a fluid containment system, such as a piping system (228, 230), while the connection between each pair of sequential bodies forms a fluid path to flow therethrough. Each decontamination body (210, 212, 214) can include an inlet (216, 220, 224) having a nozzle (not shown) that is configured to induce hydrodynamic cavitation within the fluid as it enters a respective decontamination body. Moreover, each decontamination body (210, 212, 214) can include a 3DOS substrate section (218, 222, 226) that encounters the fluid as it flows through the respective decontamination body. As such, sequentially arranging such decontamination bodies (210, 212, 214) further extends the volume of fluid exposed to cavitation forming conditions, and thereby enhances the decontamination of the fluid. As depicted in FIG. 8, a fluid flowing through a piping system 228 enters a first decontamination body 210 via a first inlet 216 nozzle, wherein cavitation formation is induced by the first nozzle and extended across the fluid as it flows through a first 3DOS substrate section 218. The fluid exits the first decontamination body 210 and flows through a second (212) and third (214) decontamination body sequentially, each decontamination body inducing cavitation formation via the respective inlet (220, 224) nozzle, and extending such cavitation forming conditions within the fluid via the respective 3DOS substrate section (222, 226). The fluid enters a piping system 230 after exiting the third decontamination body 214.

With continued reference to FIG. 8, the inlet nozzles can be configured to spray the fluid in an evenly distributed manner that induces cavitation formation within the fluid, and evenly distributes the fluid across the respective 3DOS substrate(s). This may be achieved by any of several methods which will produce hydrodynamic cavitation, two examples of which are shown in FIGS. 19-20. Additionally, the pressure of the fluid in the piping system prior to entering the first decontamination body is high enough to account for the pressure drop across all the decontamination bodies and meet the minimum required pressure at the discharge of the decontamination apparatus 208 (i.e. pressure in the piping system downstream the last sequential decontamination body). Pressure losses across each decontamination body can include the pressure drop as the fluid flows through the respective inlet nozzle, and the pressure drop across the respective 3DOS substrate.

In an additional or alternative embodiment, the 3DOS substrate can aid in providing additional active sites that enable unwanted chemicals to undergo chemical reactions and be either destroyed or altered in the process. Examples of such reactions include catalytic reactions, i.e. chemical reactions that are accelerated through catalysts coated onto the substrate. Moreover, the 3DOS substrate can employ a selective catalyst system where different types of catalysts are applied to different areas of a given substrate. This enables a given 3DOS substrate to specifically target the unwanted toxic species and/or organic compounds that are either unharmed or remain toxic from an earlier reaction by a given type of catalyst. For example, one type of catalyst may be coated on a 3DOS substrate to initiate chemical reactions at the inlet of the substrate, while a different type of catalyst will be coated at the other end of the same 3DOS substrate to initiate a different set of chemical reactions for the remaining, or resulting, unwanted chemicals and compounds.

Examples of such catalysts/material that can be coated or sprayed (or bound) on the surface of the 3DOS substrates include oxides, such as perovskite, alumina, and/or similar material, which can act as an active surface on which unwanted or toxic species may require a lower energy for activation (for a chemical reaction) or result in adsorption/absorption, and further enhances the interaction of the unwanted/toxic species. Additional catalyst examples would include the application of catalytic species, such as noble or non-noble metal species, onto the coated surfaces, wherein the coated surfaces maybe alumina or similar catalyst support material. In addition or alternatively, an oxide or similar material can be coated or sprayed (or bound) on the surface of the substrates to act as a surface on which a catalyst may be incorporated to lower the energy for activation, while another material may be sprayed or coated to enhance the activity of a catalyst. An example of a reaction taking place on a modified metal foam surface 3DOS substrate could be an oxidation reaction between an oxide surface, dissolved oxygen, and/or toxic hydrocarbon that is similar to any catalytic hydrocarbon oxidation process.

In yet another embodiment, only the inlet of a given 3DOS substrate may be applied with catalysts to accelerate chemical reactions. The remaining surface of the given substrate may instead be coated or treated with material that will absorb or adsorb the species and/or compounds generated at the catalytic sites, so as to complete the removal process of the unwanted toxic species and/or organic compounds. Zeolites and metalorganic framework (MOF) chemicals are examples of materials that can be coated on the substrate that will aid in such absorption and/or adsorption.

It should be appreciated that the use of 3DOS substrates can be used with any combination of existing fluid decontamination methods. For example, 3DOS substrates can be used where hydrodynamic cavitation, sonication, catalytic reactions, and absorption/adsorption are all used together.

In an alternate or additional embodiment, injection nozzles for each inlet can be configured to increase the fluid flow turbulence by injecting the contaminated fluid with air at medium or high pressure, thereby resulting in droplets, voids, and/or regions of varying pressure that impinge onto each 3DOS substrate surface. Including air in the inlet nozzle as it sprays contaminated fluid aids in incorporating areas of voids within the 3DOS substrate as the fluid flows therethrough. As such, by increasing the fluid flow turbulence, such injection nozzles enable to 1) induce hydrodynamic cavitation formation by spraying directly onto the 3DOS substrate, and 2) increase interaction between the contaminated fluid and 3DOS substrates to enable chemical reactions involving unwanted chemicals to be carried out. Air can be received from an external air supply and injected into the liquid feed stream.

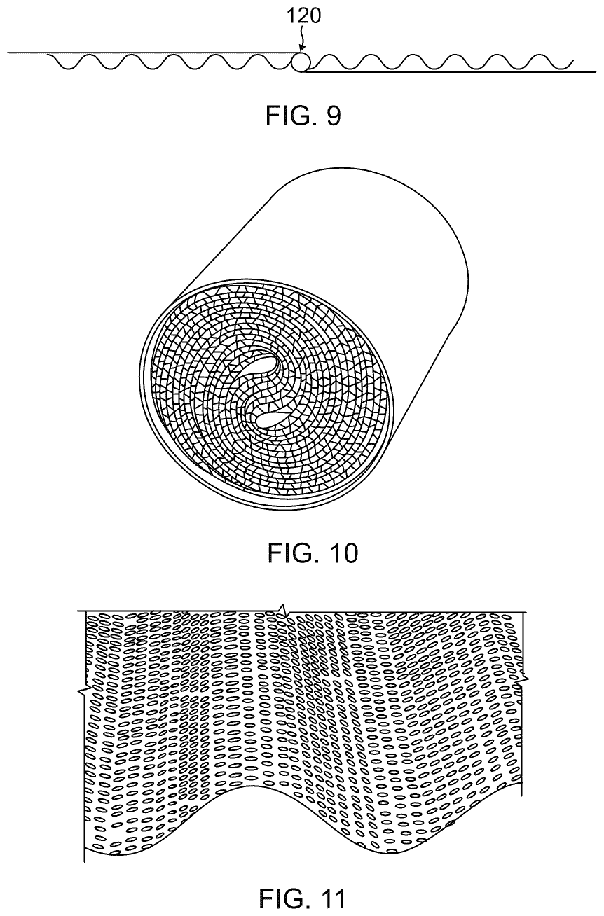

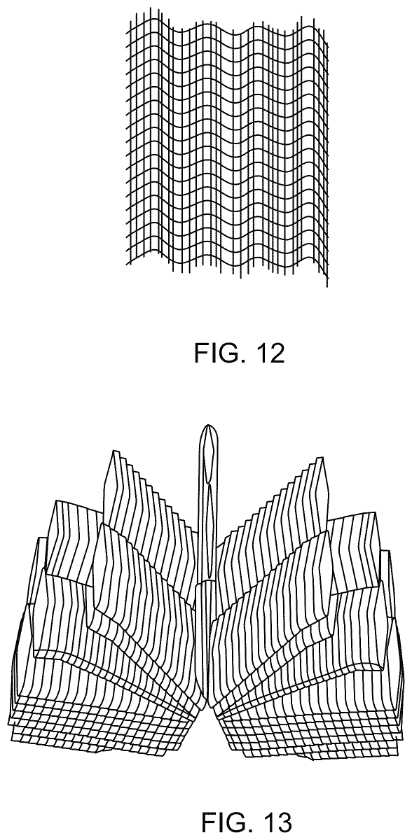

With reference to FIGS. 9-13, use of corrugated metal structures, created by any of several methods including, but not limited to, winding corrugated and/or smooth strips of metal, may also be employed, either in place of metal alloys configured as metal foam, or in conjunction with such metal foams. Likewise, emplacement of a monolith, which incorporates a series of wound corrugated and/or smooth metal strips, may be employed in place of metal foam, to serve much the same purpose that metal foam has been described previously to provide. The monolith can be wound with a mandrel 120 (FIG. 9), or without (FIG. 10), and can be wound to a given dimension that matches the inside container body or pipe diameter (similar to the 3DOS substrate (52) depicted in FIG. 3). Moreover, the metal strips can be wound along a mandrel or unit center in different configurations, such as corrugations from the different metal strips aligned at opposite angles, metal strips of varying lengths, and/or using strips of alternating length/angle. Types of metal strips that can be wound include layers of corrugated (FIG. 12) or similarly deformed metal strips, layers of perforated corrugated metal strips (FIG. 11), and/or layers in which the corrugations or deformations do not nest together i.e. the corrugations/deformations do not collapse together and thereby retain the original open structure desired (between the metal strip layers), such that smooth metal strips may not be needed. Moreover, the use of metal strips corrugated at angles, such as in the shape of a chevron (FIG. 13) or herringbone, may be employed with the perforations either randomly or uniformly in place, or can vary within a section of the sheet. In an alternative embodiment, the corrugated and/or angled corrugated metal strips may be layered on top of each other instead of being wound around a mandrel, wherein the strips are layered without nesting. The angle of corrugation can be varied to correspond to varying pores per inch (ppi), i.e from large ppi to small ppi. The treatment of the corrugated metal monolith surfaces to retain the properties previously described for metal foam, including catalytic and adsorption/absorption surfaces, may be employed. Moreover, any combination of the aforementioned use of corrugated and/or smooth metal strips, varying angles, metal strip lengths, etc. can be used to manipulate the degree of decontamination attained. In any case, where foam or layered strips are employed, the entire cross-section of the body (reactor) is completely exposed to the 3DOS substrate to eliminate any possible by-pass of the flowing liquid from not flowing through the 3DOS substrate.

Furthermore, an alternative to metal strips may be the use of wire mesh than can also be wound into cylinders that take various shapes and configurations that result in tumultuous flow into, and through, the bed in similar fashion to the flow through a metal foam. Alternatively, the wire mesh can be implemented to form a packed bed of wire mesh to provide the desired three dimensionally open structure. Likewise, these surfaces may be altered in similar fashion as described for metal foam surfaces and metal strips to enhance catalytic and adsorption/absorption properties, including varying features over a length of a given section.

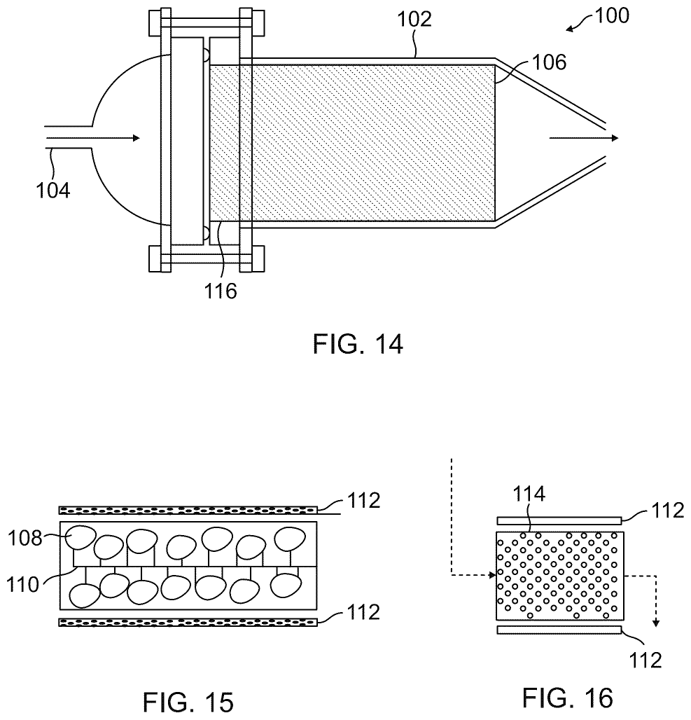

With reference now to FIG. 14, an alternative embodiment is depicted of a fluid decontamination apparatus in accordance with the present invention, which include a reactor chamber 100 and a 3DOS substrate 106 disposed within a section of the reactor chamber 100. The reactor can comprise of metal and/or an ultraviolet (UV) transparent material, e.g. quartz 102. The use of quartz 102 for both the reactor chamber and the substrate enables UV spectral irradiation to be exposed to the fluid flow therein, wherein lamps/source of UV can be located external to and surrounding the reactor. As such, the entire outer surface of the quartz reactor is exposed to UV radiation.

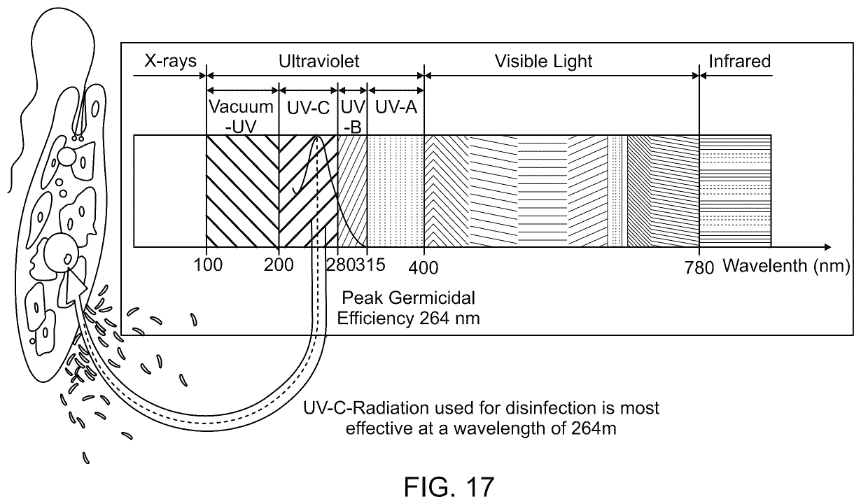

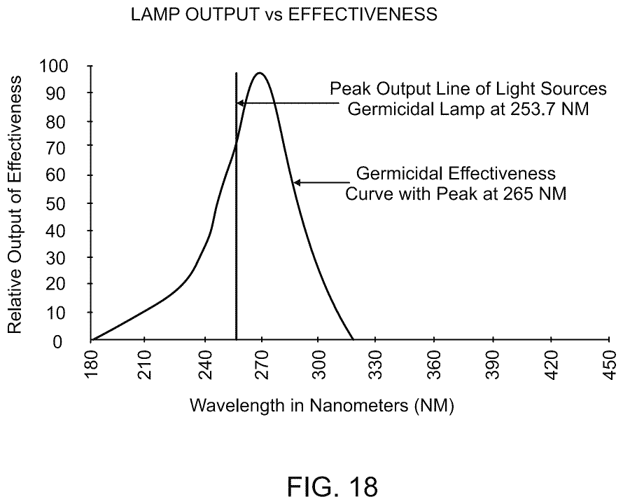

Exposing fluid to UV spectral irradiation may be desired to destroy biological species and/or very stable organic compounds found in the fluid. Ranges of UV wavelengths for effectively destroying such biological species and/or stable organic compounds are depicted in FIGS. 17 and 18. Such UV spectral irradiation can be achieved by use of a quartz-walled reactor that will permit unobstructed UV light from germicidal UV lights to penetrate the flowing fluid.

By combining the cavitation process (from injecting fluid in a turbulent manner) in conjunction with a 3DOS substrate, in the presence of UV light, the completion of the destruction of these unwanted materials can be achieved. However, because of the desire to permit the UV light to penetrate into and throughout the fluid as it passes through the 3DOS structures, as aforementioned, the material selection for said 3DOS will be quartz, rather than the material selection presented above (such as metal alloy). Referring now to FIGS. 15-16, the quartz 3DOS can take the form of either 1) a packed bed of quartz particles 114 (FIG. 16), such as beads, shards or pellets, or 2) the implementation of a structure 110 which rigidly holds quartz particles 108 in a fixed position (FIG. 15). Either approach will serve the same purpose of combining the enhancement of cavitation, a tortuous fluid flow path, and continuous exposure to UV light by germicidal UV lights 112. Moreover, in either approach, the quartz 3DOS can include a porous structure. Referring now to FIG. 14, the quartz 3DOS structures can be configured to fit 116 within grooves in endplates for respective O-ring gaskets within the reactor, and aligned with the inlet orifice or venturi 104 enabling hydrodynamic cavitation at the entrance of the reactor.

The desired decontamination effects through the incorporation of foam inserts could be further improved with alternative designs and arrangements of the foam inserts. Variables to the foam inserts include shapes and configurations by which the hydrodynamic flow generating the cavitation process interacts with the foam in a manner that could increase the effectiveness of both the physical cavitation process and the chemical reactions taking place. Discussed further is how the positioning, configuration, and arrangement of foam rings or foam elements may be suited to a given cavitation zone geometry.

Various configurations of foam inserts are illustrated representing the possibility of varying the foam configurations would cause the interaction of the primary generation of the hydrodynamic cavitation to be enhanced throughout the developed cavitation zone. By incorporating the various shapes and/or configurations of foam, the combined effects of these alternatives with the primary generation of hydrodynamic cavitation will provide a significant improvement in decontamination effects. The various specific shape and/or configuration choices may be particularly well-suited for optimal chemical activity as the generation of hydrodynamic cavitation can vary. The skilled artisan would appreciate that the foam shape/configuration shown and described illustrate a framework for the geometries and parameters that can be tailored to best suit the flow dynamics within a given channel under certain conditions. Varying effects are achieved by including voids at the central flow axis versus including voids around the outer perimeter of the foam inserts, generating different turbulence relative to the reaction zone. The mix of voids and foam surfaces throughout the reaction zone can be modified and varied based on flow conditions and desired cavitation generation patterns.

The present embodiments demonstrate the invention in the context of a single orifice, but the skilled artisan would recognize the principles apply likewise to configurations with multiple orifices, including orifices arranged in series, in parallel, or orthogonal to one another. The maximum pressure differential must occur at the orifice, otherwise cavitation is terminated. It should be appreciated that the pressure differential through the foam or downstream of the foam cannot interfere with the pressure differential at the orifice, as doing so terminates hydrodynamic cavitation. Exemplary parameters that could inhibit cavitation include foam porosity being too great or pressure differential downstream of the orifice being too high.

The reaction zone begins at the orifice exit, where the upstream venturi induces an initial state of hydrodynamic cavitation, and ends where the fluid is finally expanded and is no longer in a state of cavitation. When the fluid is no longer in a state of cavitation, there is no more interaction between cavitation bubbles and system elements. Preferably, the cavitation does not terminate until downstream of the foam rings and/or conical 3DOS material. The reaction zone is a function of the size of the orifice and the flow (i.e., the dynamics associated with cavitation).

The variable of spacing, thickness, diameter, and porosity may be varied based on the flow profile and the fluid dynamics at play in the incident system. Some exemplary parameters defining the fluid profile may include volumetric flowrate, velocity, and fluid viscosity.

The spacing of the first foam ring downstream of the orifice may also be varied, and this could be a critical placement so as to have the 3DOS foam rings in the reaction zone while the fluid is in a state of hydrodynamic cavitation. Additionally, the segmented foam rings may have variable thickness. An advantageous thickness of a given foam ring may be selected in accordance with the expansion rate of the fluid. The segmented foam rings may also have variable diameters. According to one embodiment, each foam ring may have a uniform diameter relative to the other foam rings in the system. According to a preferred embodiment, the foam rings include progressively increasing diameters, such that the diameter of a given foam ring is larger than the diameter of an adjacent upstream foam ring. According to an embodiment, the foam rings define an expanding channel within the pipe that expands in accordance with the flow interaction. The angle of flow may also be modified or manipulated to induce surface interactions between fluid flow and the foam ring edges.

It should further be appreciated that the diameter of the tube makes a difference in terms of driving overall flow. For instance, if the diameter of the tube is increased, the orifice size will be increased accordingly in order to generate hydrodynamic cavitation. According to a preferred embodiment, a tube having a 1.6 inch inner diameter is used.

Advantageous embodiments include those that are suitable to be mechanically affixed within the channel within the system operation in a simple and reliable manner. Foam rings may be easily included within the channel due to the substantially equal diameters, facilitating easy placement. Use of foam rings may be particularly advantageous due to the flexibility in configuration, and potential for modular assembly for tailing the foam ring configuration in accordance with different flow and fluid dynamics, as required for a specific function or conditions. For instance, the foam rings may be offset with spacing at a desired distance. Further, the offset between the orifice and the first foam ring downstream of the orifice may be adjusted to be optimized to the flow profile and fluid dynamics. Further, multiple foam rings having the same diameter but different porosity, material type, cross-sectional profile, etc., may be interchangeable for optimizing the foam ring porosity to the flow profile and fluid dynamics. Therefore, a foam ring configuration allows for a high degree of freedom of variation, allowing seamless modification of grading based on parameters including thickness, porosity/density, catalyst loading, etc. The skilled artisan would recognize the implementation is based on what is most amenable to the system design, maintenance, and related factors. Although for ease of construction it is advantageous to have the foam rings have an outer diameter equal to the diameter of the channel, according to alternative embodiments, the outer diameter of one or more foams rings may be less than the diameter of the channel, and may be affixed by alternative means, for instance via a circumferential fixture.

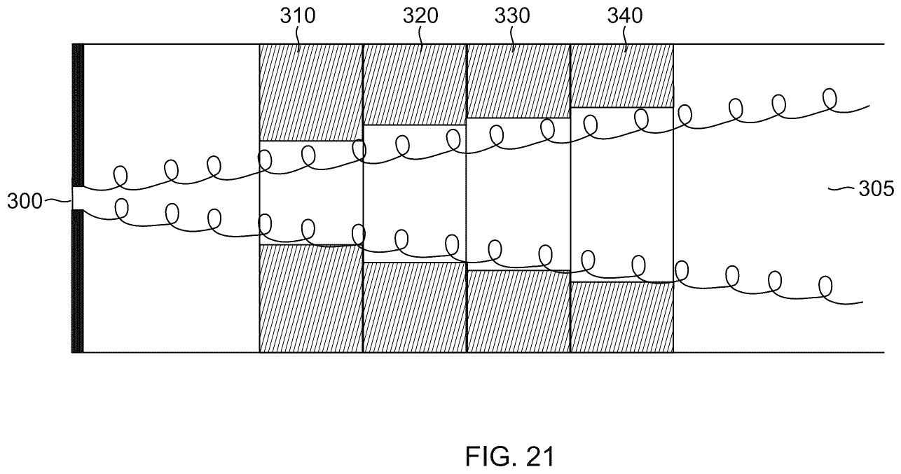

FIG. 21 shows a first foam ring configuration, where a plurality of foam rings 310, 320, 330, 340 are sequentially arranged at an offset from the orifice 300, and an internal flow path is formed axially through the central axis of the channel 305 through the voids. In this configuration, the first foam ring 310 is located at a given distance away from the orifice 300. All foam rings 310, 320, 330, 340 have an outer diameter substantially equal to the diameter of the channel 305. The first foam ring 310 has an inner diameter defining an axial void through the central axis of the channel 305. A second foam ring 320 is disposed immediately downstream of the first foam ring 310, and includes an inner diameter greater than that of the first foam ring 310, thereby creating flow expansion from the first foam ring 310 to the second foam ring 320. A third foam ring 330 is disposed immediately downstream of the second foam ring 320, and includes an inner diameter greater than that of the second foam ring 320. A fourth foam ring 340 is disposed immediately downstream of the third foam ring 330, and includes an inner diameter greater than that of the third foam ring 330.

The location of the foam ring assembly can be varied. According to one embodiment, the foam ring arrangement is located directly downstream of the orifice 300 so that it extends cavitation immediately upon cavitation generation. According to another embodiment, the foam ring arrangement can be located at an offset from the orifice 300 to extend cavitation just as it starts dying down. According to yet another embodiment, the foam ring arrangement can be located at an offset far enough that cavitation ceases, and the foam rings restart cavitation. Offsetting the first foam ring 310 from the orifice 300 is advantageous because it takes advantage of the turbulence created in the reaction zone, and modifies the degree of interaction with the foam rings 310, 320, 330, 340 and the extension of cavitation, especially when the foam rings 310, 320, 330, 340 are catalyzed.

According to an alternative embodiment, the internal diameter of each foam ring 310, 320, 330, 340 may be identical, thus defining a uniform internal flow path. According to another embodiment, two or more foam rings 310, 320, 330, 340 may have an identical inner diameter. According to yet another embodiment, the diameters may be varied in different advantageous configurations suited to the fluid dynamics within the channel 305.

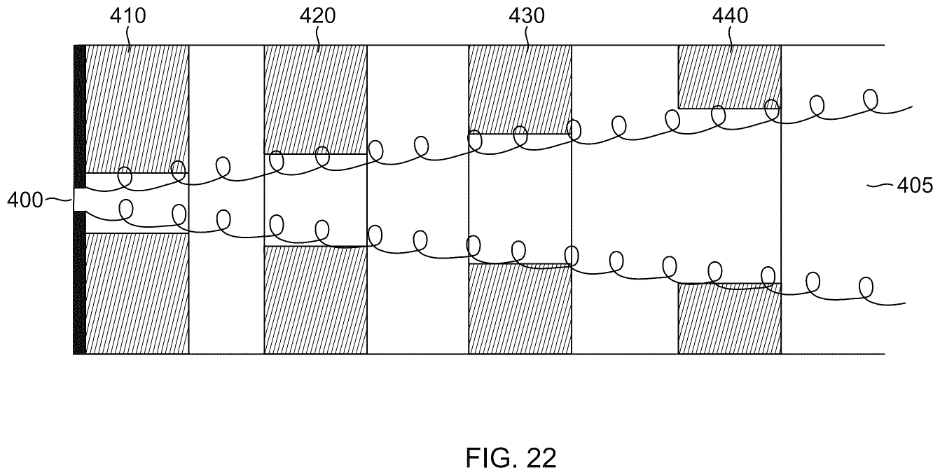

FIG. 22 shows a second foam ring configuration for arrangement of sequential foam rings 410, 420, 430, 440 within a channel 405, where the respective foam rings 410, 420, 430, 440 can be offset from one another via intermediate spacers such that they are incrementally spaced apart from one another at given distances. All foam rings 410, 420, 430, 440 have an outer diameter substantially equal to the diameter of the channel 405. In this configuration, the first foam ring 410 is disposed immediately downstream of the orifice 400. The first foam ring 410 may include an inner diameter defining a void axially extending through the central axis of the channel 405. A second foam ring 420 having a greater inner diameter than that of the first foam ring 410 may be located downstream of the first foam ring 410, offset by a given distance. A third foam ring 430 having a greater inner diameter than that of the second foam ring 420 may be located downstream of the second foam ring 420, offset by a given distance. A fourth foam ring 440 having a greater inner diameter than that of the third foam ring 430 may be located downstream of the third foam ring 430, offset by a given distance.

According to an embodiment, each foam ring 410, 420, 430, 440 may be spaced apart at an equal distance. According to an alternative embodiment, the spacing between respective adjacent foam rings 410, 420, 430, 440 can be varied from one another. A technical effect of segmenting the foam rings 410, 420, 430, 440 is to enhance the generation of turbulence, thereby assisting in mixing the reaction intermediates that are generated in the reaction zone. The thickness of the respective foam pieces 410, 420, 430, 440 and the distance between them can be adjusted in accordance with the flow and fluid dynamics in the channel 405. According to an embodiment, the various foam rings 410, 420, 430, 440 may be varied in material, porosity, and diameter, and these parameters may be matched to the fluid dynamics of the fluid exiting the orifice 400. Additionally, the cross-sectional profile could be varied, for instance the shape of the pores may be variable to induce varying effects, for example triangular shapes, circular shapes, square shapes, star shapes, etc.

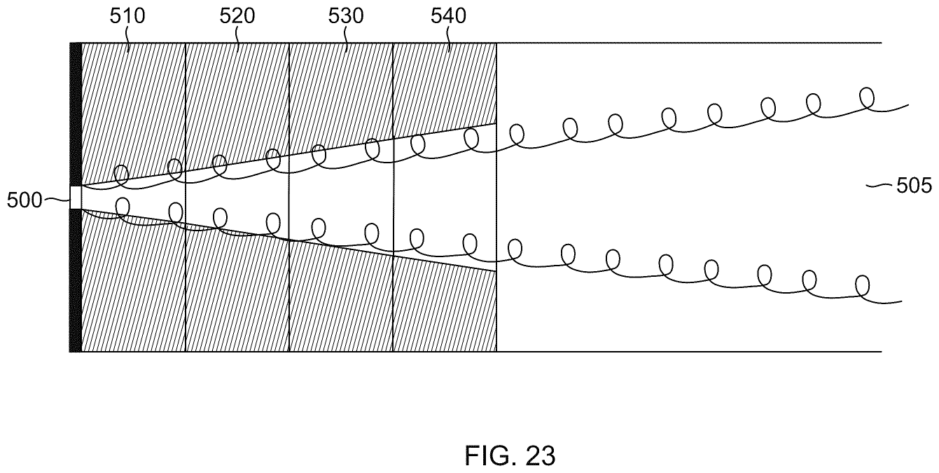

FIG. 23 shows a third foam ring configuration, where a plurality of foam rings 510, 520, 530, 540 are sequentially arranged in a channel 505 and each foam ring 510, 520, 530, 540 includes a tapered void profile having an inlet diameter and an outlet diameter where the outlet diameter is larger than the inlet diameter. Preferably, the inlet diameter of a downstream foam ring 520, 530, 540 is equal to the outlet diameter of the adjacent upstream foam ring 510, 520, 530. Additionally, the inlet diameter of the first foam ring 510 is equal to the diameter of the orifice exit 500. According to a preferred embodiment, a plurality of foam rings 510, 520, 530, 540 (e.g., four foam rings) may be included in a sequential manner to create an elongated tapered conical internal flow path along the cavitation zone. According to an embodiment, the geometry of the tapered conical internal flow path created by the sequentially arranged foam rings 510, 520, 530, 540 matches the geometry of the plume exiting the orifice 500. This is beneficial because there is a dynamic relationship between the center and edge of the water expelled from the orifice 500, and as the flow progresses downstream, the reaction zone shape and reaction intermediates undergo a continued interaction with the turbulence and the surface catalytic effect of the foam.

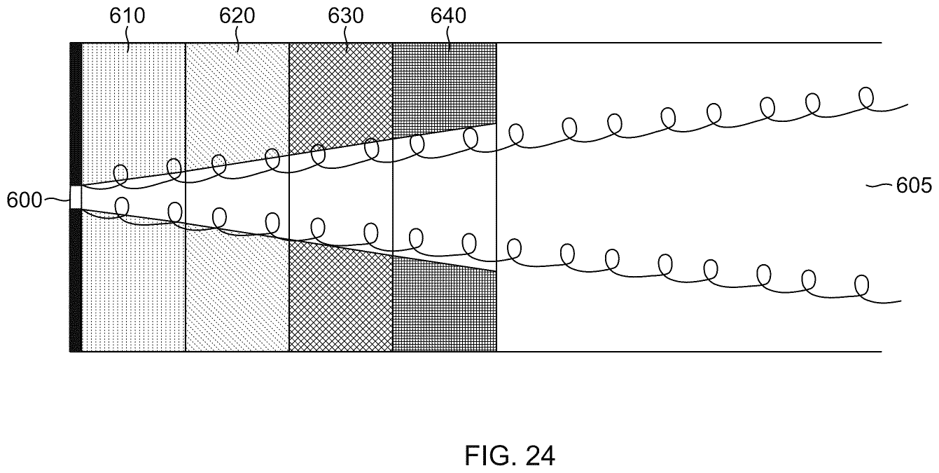

FIG. 24 shows a variation of the third foam ring configuration, wherein each foam ring 610, 620, 630, 640 in the channel 605 includes a different pore density. According to an advantageous embodiment, the foam ring pore density increases in a stepwise manner from one foam ring 610, 620, 630, 640 to the next. For instance, a first foam ring 610 may have a porosity of 5 ppi, a second foam ring 620 downstream of the first foam ring may have a porosity of 10 ppi, a third foam ring 630 downstream of the second foam ring 620 may have a porosity of 15 ppi, and a fourth foam ring 640 downstream of the third foam ring 630 may have a porosity of 20 ppi. The selective gradations in the pore density have the advantageous effect of enhancing cavitation effects. More specifically, the rate of expansion of the flow from the orifice 600 and the subsequent turbulence created with the interaction with foam rings 610, 620, 630, 640 will vary. Depending on the degree of penetration of portions of the species in the water, the rate of reaction, and the intermediates created due to the cavitation, will vary as the reaction zone expands to the downstream channel wall.

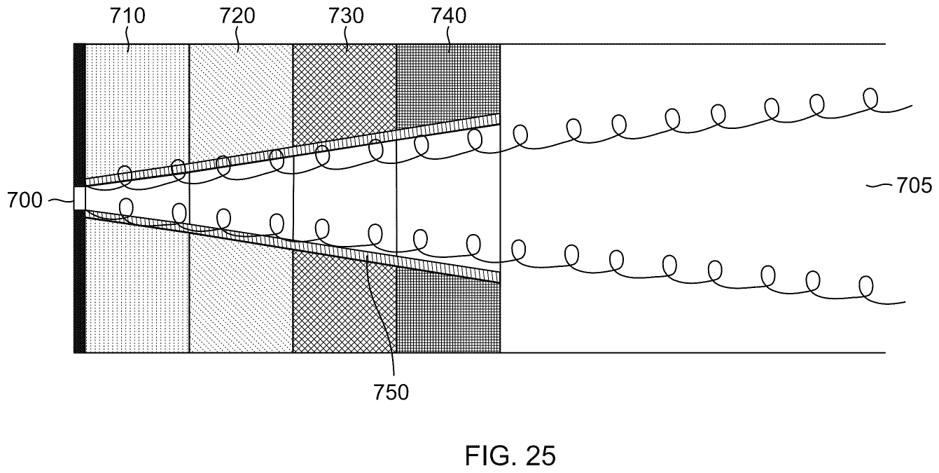

FIG. 25 shows a further variation of the third foam ring configuration, where a catalyst material 750 is further included along the inner area of foam rings 710, 720, 730, 740 arranged in the channel 705. This embodiment is shown in the context of the variable pore density configuration shown in FIG. 24 and described above. According to an embodiment, one or more catalyst 750 may be deposited on the foam ring edges such that the fluid comes into contact with the catalyst 750 while the fluid is in a state of hydrodynamic cavitation. The technical effect of the interaction between the catalyst 750 and the cavitated fluid is a boost in decontamination effects, as it results in a greater reaction and/or a greater likelihood of the interaction occurring. According to an embodiment, each foam ring 710, 720, 730, 740 may have a different catalyst 750, which may be advantageous for inducing a broader range of reactions. According to an alternative embodiment, the foam ring material itself could function as a catalyst 750 rather than a catalyst 750 being deposited on the material, for instance as a coating. Alternatively, the foam ring material may be completely catalyzed by other known methods, rather than only the inner surface of the foam rings 710, 720, 730, 740 being catalyzed. The selection of catalyst type and configuration may be based on what achieves the best interaction with the fluid dynamics of the flow. The catalyst loading can also be varied. The skilled artisan will recognize that parameters including catalyst material, catalyst loading, pore density, and thickness may be modified to facilitate the best interaction with the flow dynamics of the flow.

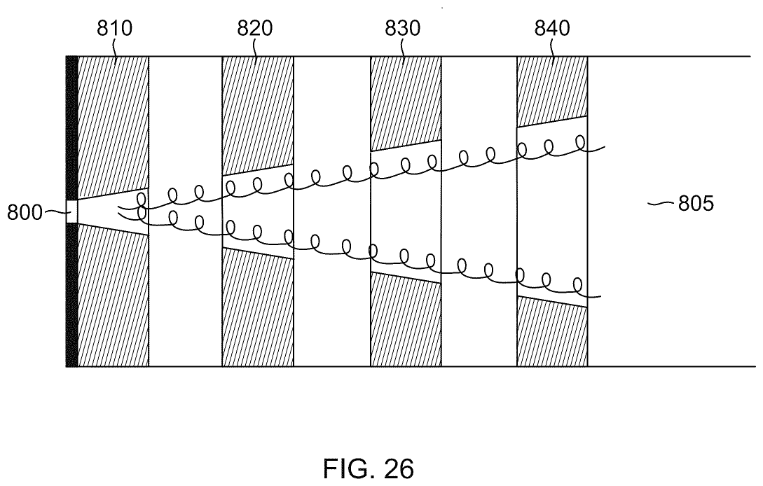

FIG. 26 shows a fourth foam ring configuration, in which a plurality of foam rings 810, 820, 830, 840 are sequentially arranged and each foam ring 810, 820, 830, 840 includes a tapered void profile having an inlet diameter and an outlet diameter where the outlet diameter is larger than the inlet diameter, and each of the respective foam rings 810, 820, 830, 840 are offset from one another via intermediate spacers such that they are incrementally spaced apart from one another at given distances. All foam rings 810, 820, 830, 840 have an outer diameter substantially equal to the diameter of the channel 805.

Each foam ring 810, 820, 830, 840 includes a tapered void profile having an inlet diameter and an outlet diameter, where the outlet diameter is larger than the inlet diameter. The first foam ring 810 may be disposed immediately downstream of the orifice 800, and may have an inlet diameter equal to the diameter of the orifice exit 800. A second foam ring 820 may be located downstream of the first foam ring 810 at an offset of a given distance, and have an inlet diameter greater than the outlet diameter of the first ring 810. A third foam ring 830 may be located downstream of the second foam ring 820 at an offset of a given distance, and have an inlet diameter greater than the outlet diameter of the second foam ring 820. A fourth foam ring 840 may be located downstream of the third foam ring 830 at an offset of a given distance, and have an inlet diameter greater than the outlet diameter of the third foam ring 830.

According to a preferred embodiment, a plurality of foam rings 810, 820, 830, 840 (e.g., four foam rings) may be included in a sequential manner to create an elongated tapered conical internal flow path along the cavitation zone. In this configuration, a uniform linear slope is maintained for the conical internal flow path defined by the foam rings 810, 820, 830, 840, with the profile of each segmented foam ring 810, 820, 830, 840 aligned to the same sloped axis despite the spacing between them. According to an embodiment, the geometry of the tapered conical internal flow path created by the sequentially arranged offset foam rings 810, 820, 830, 840 matches the geometry of the plume exiting the orifice 800.

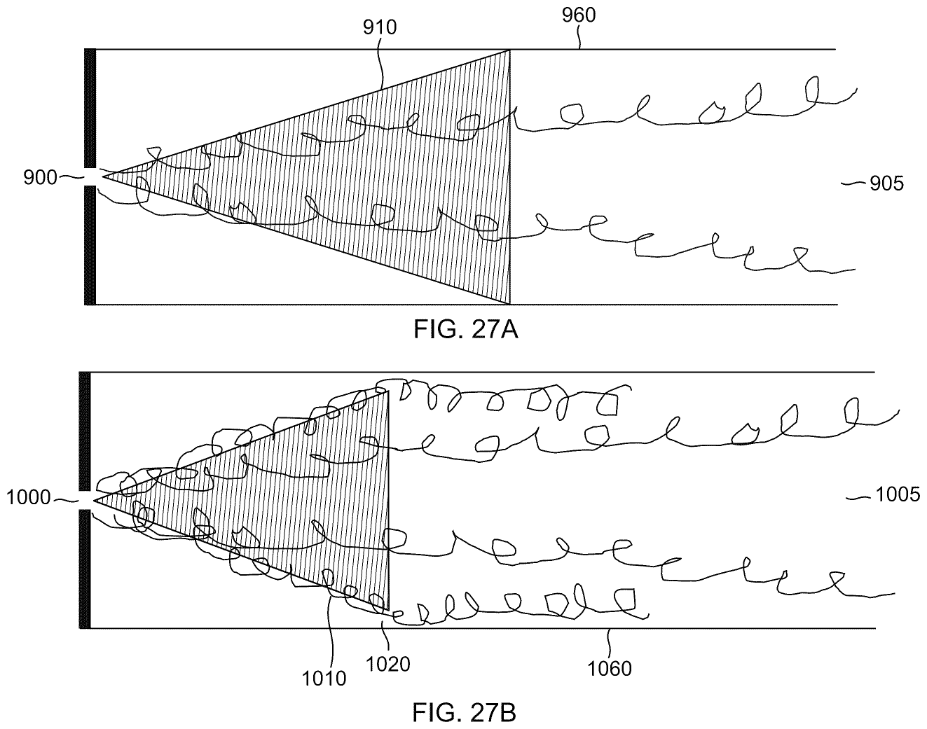

FIG. 27A shows a configuration featuring a first foam insert shape, where a conical-shaped 3DOS foam element 910 may be included within the channel 905. At the orifice 900, the conical foam element 910 has its minimum diameter, and the diameter of the foam substrate 910 increases linearly downstream of the orifice 900 until approaching the channel wall 960. According to an embodiment, the conical foam element 910 may have substantially the same maximum diameter as the channel 905, such that the conical foam 910 is in contact with the channel wall 960. According to a preferred embodiment, the profile of the conical foam element 910 substantially matches the profile of the plume exiting the orifice exit 900.

FIG. 27B shows a variation of the first foam insert shape configuration, where instead of the conical foam element 1010 extending all the way to the channel wall 1060, the conical foam element 1010 may have a maximum diameter less than the diameter of the channel, thereby leaving a circumferential bypass gap 1020 near the channel wall 1060. Therefore, the diameter of the foam insert 1010 creates a gap 1020 near the channel wall 1060 instead of the foam element 1010 abutting against the channel wall 1060. This gap 1020 is formed in the space between the inner diameter of the channel 1005 and the maximum diameter of the foam element 1010. The circumferential diameter difference defining the bypass 1020 may be variable, namely a function of the downstream pressure differential the orifice 1000 is designed for, the void density or porosity of the foam, and the length of the conical element 1010. The flow through the bypass 1020 can be arranged to interact with the surface of the foam cone 1010 as well as passing through the foam 1010, depending on the pressure differential at the orifice 1000. The inclusion of the gap 1020 between the outside diameter of the conical foam element 1010 and the channel wall 1060 allows for a pinch effect that influences the degree of penetration the water will experience through the conical foam element 1010.

A foam having a higher porosity correlates to a higher pressure differential, which would translate to a smaller conical element 1010 because the pressure differential through the foam would disrupt the pressure differential across the orifice 1000. According to a preferred embodiment, the geometry of the conical foam element 1010 is matched to the geometry of the plume exiting the orifice 1000, such that it matches to slope of expansion.

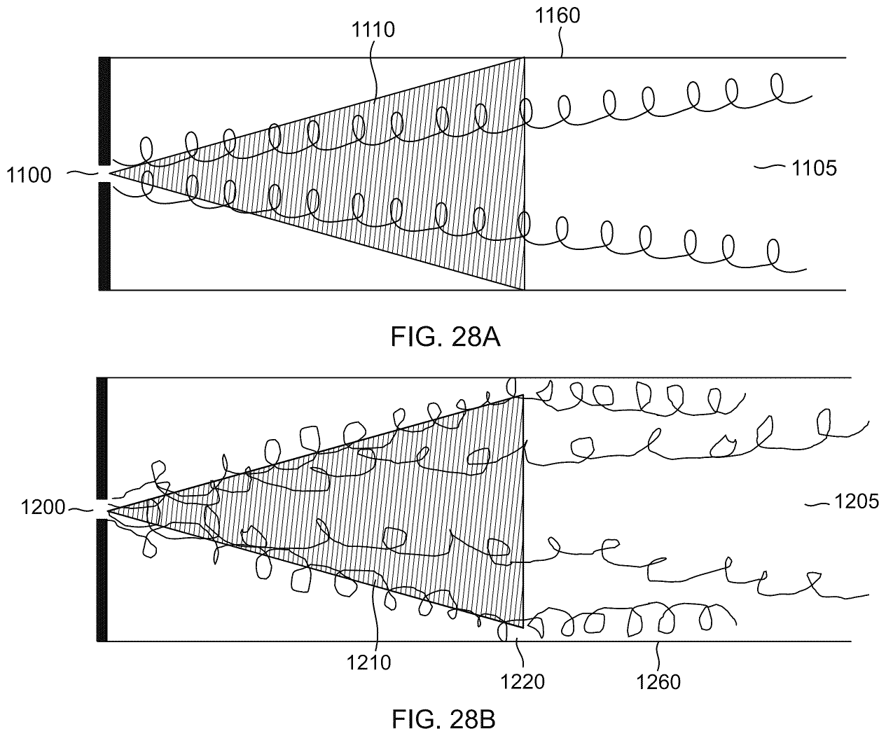

FIG. 28A shows a further variation of the first foam insert shape configuration, where the conical foam element 1110 is elongated such that extends further downstream from the orifice 1100. This represents how the length dimension of a foam element 1110 may be varied to best accommodate the flow dynamics in the channel 1105, for instance to mirror to expanding flow profile of fluid exiting the orifice 1100. In this configuration, the outer diameter of the conical foam element 1110 abuts against the channel wall 1160.

FIG. 28B shows yet a further variation of the configuration featuring the first foam insert shape, where instead of the conical foam element 1210 extending all the way to the channel wall 1260, a circumferential bypass gap 1220 is included near the channel wall 1260 instead of the foam element 1210 abutting against the channel wall 1260. This gap 1220 is formed in the space between the inner diameter of the channel 1205 and the maximum diameter of the foam element 1210. The same dynamics apply here as in FIGS. 27B, but here the length of conical foam element 1210 differs, allowing for different pathlengths of flow both through the foam insert 1210, and around it via the bypass 1220. The diameter of the foam insert 1210 allows for creation of a bypass 1220, since the foam element 1210 does not extend to the channel wall 1260. The diameter of the foam insert 1210 can be varied to achieve a desired bypass gap 1220 size. Depending on pressure differential, fluid may be directed to interact with the surface of the conical foam element 1210, as well as pass through the foam element 1210 itself. An advantageous effect of including the bypass 1220 is to possibly induce further cavitation via the venturi effect as fluid flows through the gap 1220 near the channel wall 1260 and subsequently drastically expands outward.

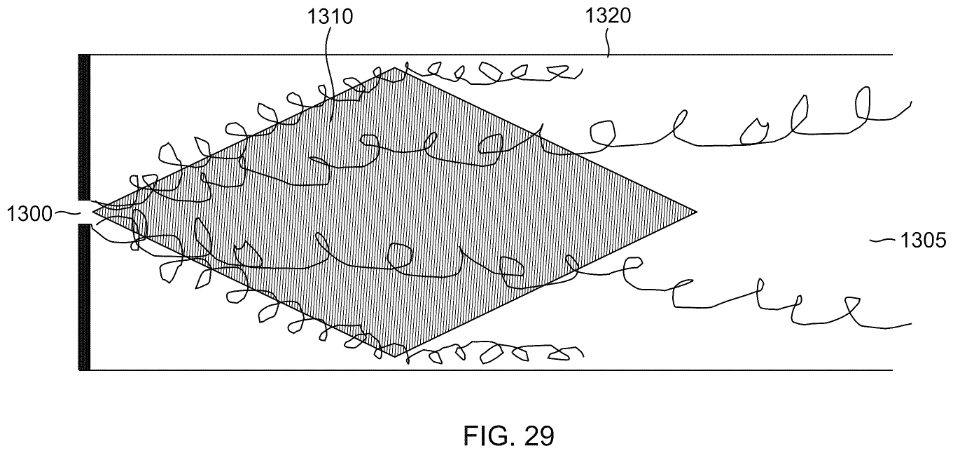

FIG. 29 shows a configuration featuring a second foam insert shape, in which the foam is formed as a bicone foam element 1310. The bicone shape is defined by a conical shape expanding outwards from a minimum diameter to a maximum diameter, then symmetrically tapering back down to a minimum diameter. From cross-sectional side view, the bicone shape is appears as a rhombus. The bicone foam element 1310 has its minimum diameters at the orifice exit 1300 and downstream in the channel 1305 where the contracting taper ends. In this configuration, bypass gaps 1320 are included at the point along the channel 1305 where the foam element 1310 has its maximum diameter.

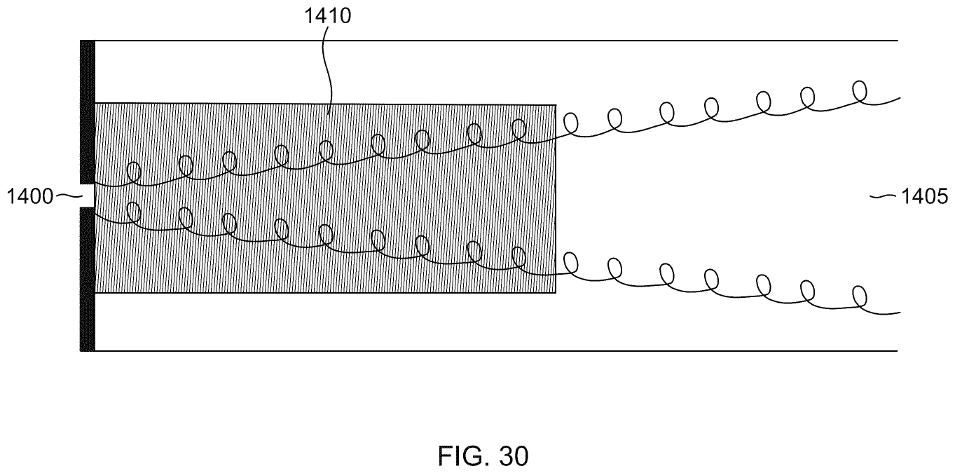

FIG. 30 shows a configuration featuring a third foam insert shape, in which a cylindrical foam element 1410 is disposed in the channel 1405 starting at the orifice 1400. This embodiment demonstrates an exemplary geometric variation for the foam element 1410, as certain variations may be advantageous in certain fluid dynamics conditions.

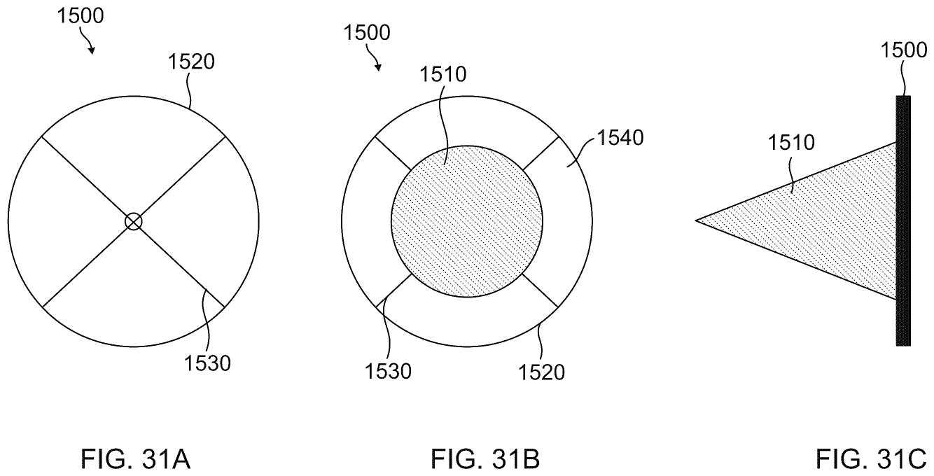

FIG. 31A shows a fixture 1500 for holding a conical foam insert 1510, shown with no conical foam insert 1510 attached to the fixture 1500. FIG. 31B shows a front view of a fixture 1500 holding a foam cone 1510. According to an embodiment, a fixture 1500 is provided for affixing a conical foam structure 1510 or segments thereof within a channel. This fixture 1500 allows for circumferential bypasses 1540 to be included between the maximum diameter section of the conical element 1510 and the channel wall. The fixture 1500 may include an outer frame 1520 having the substantially same diameter as the inner diameter of the channel, allowing the outer frame 1520 to abut against the channel wall. Thus, the fixture 1500 allows for unitary foam inserts to be included in a channel according to a similar mechanism by which the foam rings are secured in the channel according to the embodiments of FIGS. 21-26. The fixture 1500 may further include a plurality of radially-extending connection elements 1530 extending from the inner circumferential edge of the outer frame 1520 to the conical foam element 1510 to which it attaches. According to a preferred embodiment, a plurality of fixtures 1500 are included for attaching to various lengthwise sections of the conical foam element 1510, thereby ensuring consistent support and secure attachment of the conical element 1510 within the channel. In this way, the conical element 1510 may be implemented within the channel using a simple cross-piece holder. The fixture 1500 allows for the implementation of bypasses 1540 while not impacting the pressure differential of the flow.

FIG. 31C shows a side view of a fixture 1500 holding a conical foam insert 1510. In this exemplary schematic, the foam cone 1510 is attached to the fixture 1500 at the maximum diameter of the conical foam element 1510. According to further embodiments, the conical foam element 1510 can be attached to the fixture 1500 at other sections of the conical foam element 1510, for instance at an intermediate diameter point. According to another embodiment, a plurality of fixtures 1500 may hold a single foam cone 1510 in place, which may be advantageous for further redundancy for securing, or for a larger foam cone 1510. According to a preferred embodiment, the fixture 1500 may have an outer diameter of 1.6 inches, while the conical foam element 1510 has a maximum diameter of 1 inch.

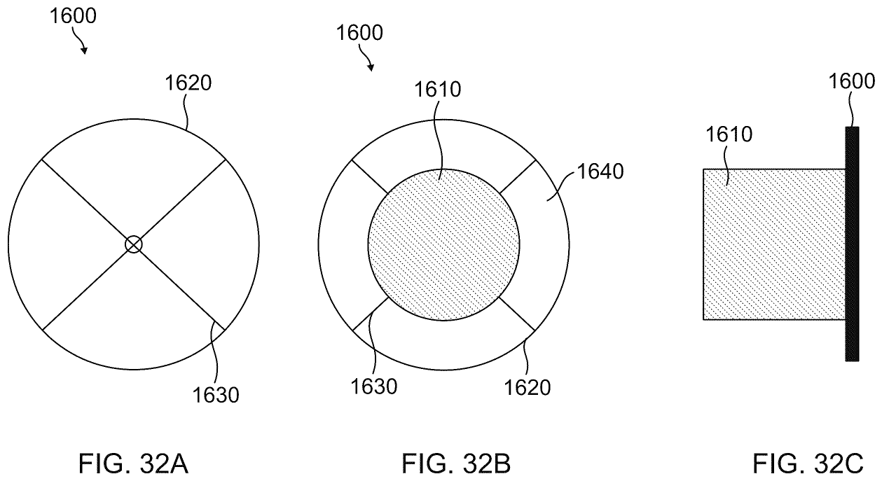

According to the embodiment shown in FIGS. 32A-C, a cylindrical foam structure 1610 may be included in the channel via a fixture 1600 arranged in the channel. FIG. 32A shows a fixture 1600 for holding a cylindrical foam insert 1610. FIG. 32B shows a front view of a fixture 1600 holding a cylindrical foam insert 1610. The fixture 1600 may further include a plurality of radially-extending connection elements 1630 extending from the inner circumferential edge of the outer frame 1620 to the conical foam element 1610 to which it attaches. This fixture 1600 allows for circumferential bypasses 1640 to be included in the space between the outer frame 1620 (i.e., at the channel wall) and the outer surface of the cylindrical foam structure 1610. FIG. 32C shows a side view of a fixture 1600 holding a cylindrical foam insert 1610. According to a preferred embodiment, the fixture 1600 may have an outer diameter of 1.6 inches while the cylindrical foam element has a diameter of 1 inch. The skilled artisan would recognize that a fixture 1500, 1600 may be adapted for securely holding in a place foam inserts of a variety of different geometries as desired to be included in the channel.

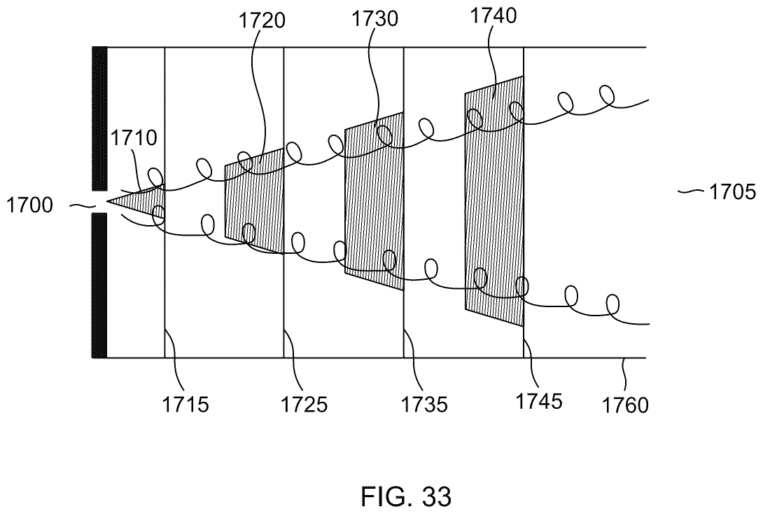

FIG. 33 shows an embodiment in which a plurality of sequentially arranged foam insert segments 1710, 1720, 1730, 1740 are included in a channel 1705. Each foam insert segment 1710, 1720, 1730, 1740 has a tapered profile where the diameter increases in the downstream direction. Each of the respective foam insert segment 1710, 1720, 1730, 1740 are offset from one another at a given distance, and the profile of each foam insert segment 1710, 1720, 1730, 1740 is aligned to the same sloped axis despite the spacing between them such that a uniform linear slope is maintained. According to an embodiment, the slope defined by the taper of the foam insert segments 1710, 1720, 1730, 1740 matches the geometry of the plume exiting the orifice 1700. The first foam insert segment 1710 may be disposed immediately downstream of the orifice 1700 and be attached to the channel wall 1760 by a first fixture 1715. A second foam insert segment 1720 may be located downstream of the first foam insert segment 1710 at an offset of a given distance, and be attached to the channel wall 1760 by a second fixture 1725. A third foam insert segment 1730 may be located downstream of the second foam insert segment 1720 at an offset of a given distance, and be attached to the channel wall 1760 by a third fixture 1735. A fourth foam insert segment 1740 may be located downstream of the third foam insert segment 1730 at an offset of a given distance, and be attached to the channel wall 1760 by a fourth fixture 1745. An advantage of this embodiment is that a conical foam structure may be segmented rather than being included as a solitary structure, allowing for the introduction of spacing between conical segments 1710, 1720, 1730, 1740.

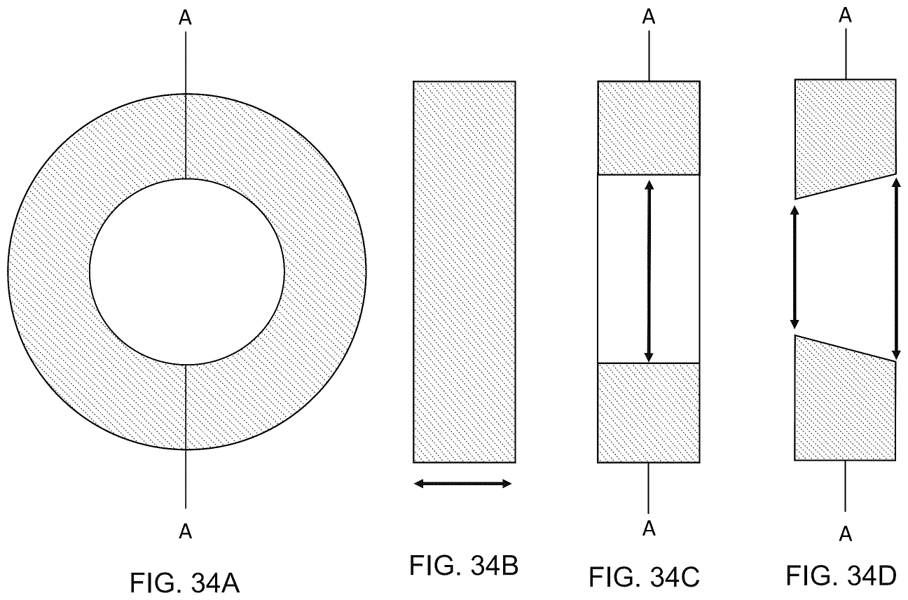

FIG. 34A shows an axial view of an exemplary foam ring element. The foam ring includes an outer diameter defined by the outer circumferential edge of the foam ring, and an inner diameter defined by the inner circumferential edge of the foam ring.

FIG. 34B shows a side view of the exemplary foam ring element. The thickness of the foam ring can be varied to optimize flow interaction.

FIG. 34C is a cross-sectional view taken along line A-A of FIG. 34A of the foam ring. According to the shown embodiment, the foam ring element has a uniform inner diameter. The inner diameter of the foam ring is a variable that may be modified to optimize flow interaction. For instance, in a configuration in which multiple foam rings are sequentially arranged in series, the inner diameter of the foam ring may be increased relative to a preceding foam ring, such that an inner channel defined by the sequential foam rings expands in the downstream direction.

FIG. 34D is a cross-sectional view taken along line A-A of FIG. 34A of the foam ring element, showing an alternative embodiment in which the foam ring has a tapered inner diameter. Accordingly, the foam ring has an inlet diameter and an outlet diameter. Both the inlet diameter and the outlet diameter are variables that may be modified to optimize flow interaction, for instance to tailor the profile of the inner channel to the plume profile flowing through the channel. The inlet diameter may be decreased to correspond to a more rapidly expanding plume, or increased to correspond to a less rapidly expanding plume. Similarly, the outlet diameter may be increased to correspond to a more rapidly expanding plume, or decreased to correspond to a less rapidly expanding plume.

It should be appreciated from the foregoing that the present invention provides a fluid decontamination apparatus having a body with a plurality of three-dimensional open structure (3DOS) substrates spaced about therein, wherein a contaminated fluid flowing through the body will contact the 3DOS substrates. Nozzles can be inserted and secured within inlet apertures disposed about the body and configured to inject the contaminated fluid with/without air to induce the occurrence of hydrodynamic cavitation. The substrates can be porous and permeable, enabling the contaminated fluid to flow therethrough, wherein the fluid flow passageway through the pores extends the volume of contaminated fluid exposed to turbulent and cavitation inducing flow conditions. Moreover, the 3DOS substrates may be coated with one or more types of catalysts, wherein the interaction between the contaminated fluid and the porous surfaces can initiate chemical reactions. As such, the extended exposure of the contaminated fluid to the formation and implosion of gaseous voids from hydrodynamic cavitation, along with the chemical reactions carried out on the porous surfaces, enable an increased number of toxic species and unwanted organic compounds to be destroyed and/or altered, thereby enhancing the decontamination of the flowing fluid.

The present invention has been described above in terms of presently preferred embodiments so that an understanding of the present invention can be conveyed. However, there are other embodiments not specifically described herein for which the present invention is applicable. Therefore, the present invention should not be seen as limited to the forms shown, which is to be considered illustrative rather than restrictive.

Although the invention has been disclosed in detail with reference only to the exemplary embodiments, those skilled in the art will appreciate that various other embodiments can be provided without departing from the scope of the invention, to include any and all combination of features discussed herein.

What is claimed is:

1. A fluid decontamination apparatus, comprising:
a continuous pipe section that enables fluid flow therethrough, the continuous pipe section having opposing ends;
an inlet nozzle coupled to a contaminated fluid source and coupled to the continuous pipe section coupled to a first opposing end of the continuous pipe section and having a nozzle opening oriented aligned with the fluid flow direction for introducing a fluid flow into the continuous pipe section, said nozzle configured to spray the fluid into the continuous pipe section to induce cavitation formation within the fluid;
at least one three-dimensionally open structured (3DOS) element disposed within the continuous pipe section and structured such that the hydrodynamic cavitation extends through the at least one 3DOS element to enable destruction of toxic species and unwanted organic compounds contained in the contaminated fluid; and
an outlet at a second opposing end of the continuous pipe section that is opposite said first opposing end of the continuous pipe section.

2. The fluid decontamination apparatus according to claim 1, wherein the at least one 3DOS element is formed in a ring shape and includes:
an inner diameter defining an inner flow channel, and
an outer diameter substantially equal to an inner diameter of the continuous pipe section.

3. The fluid decontamination apparatus according to claim 2, comprising a plurality of 3DOS elements sequentially arranged within the continuous pipe section.

4. The fluid decontamination apparatus according to claim 3, wherein at least two of the plurality of the sequentially arranged 3DOS elements are spaced apart from each other.

5. The fluid decontamination apparatus according to claim 3, comprising at least two sequentially arranged 3DOS elements having different inner diameters from one another, wherein the inner diameter of a first 3DOS element is less than the inner diameter of a second 3DOS element downstream of the first 3DOS element.

6. The fluid decontamination apparatus according to claim 5, wherein an inner channel defined by incrementally increasing inner diameters of the sequentially arranged 3DOS elements substantially matches the profile of a plume of fluid exiting the nozzle, thereby achieving greater decontamination effect.

7. The fluid decontamination apparatus according to claim 5, wherein the inner diameter of each 3DOS element widens along a flow path to form a plurality of local conical inner channels defined by the inner surface of each 3DOS element, each local conical inner channel having:
an inlet diameter, and
an outlet diameter downstream of the inlet diameter, said outlet diameter being greater than the inlet diameter.

8. The fluid decontamination apparatus according to claim 7, wherein the outlet diameter of a first 3DOS element is equal to the inlet diameter of a second 3DOS element sequentially arranged immediately downstream of the first 3DOS element.

9. The fluid decontamination apparatus according to claim 7, wherein the sequentially arranged 3DOS elements are spaced apart from each other, and the inner surfaces of the 3DOS elements collectively define a conical inner channel having a uniform taper angle, despite the spacing between adjacent 3DOS elements.

10. The fluid decontamination apparatus according to claim 2, wherein the apparatus includes at least two 3DOS elements having different pore densities from one another, and wherein the pore density of a first 3DOS element is less than the pore density of a second 3DOS element sequentially arranged downstream of the first 3DOS element, and wherein the pore size of the first 3DOS element is larger than the pore size of the second 3DOS element.

11. The fluid decontamination apparatus according to claim 2, wherein an inner surface of at least one 3DOS element is coated with a catalyst, to initiate chemical reactions that enable destruction of toxic species and unwanted organic compounds contained in the contaminated fluid.

12. The fluid decontamination apparatus according to claim 1, wherein the at least one 3DOS element has a conical shape having a minimum diameter proximate to the nozzle, and a maximum diameter downstream of the minimum diameter, wherein the maximum diameter is greater than the minimum diameter.

13. The fluid decontamination apparatus according to claim 12, wherein the maximum diameter of the conical 3DOS element is substantially equal to an inner diameter of the continuous pipe section.

14. The fluid decontamination apparatus according to claim 12, wherein the inner diameter of the continuous pipe section is greater than the maximum diameter of the conical 3DOS element, and a ring-shaped circumferential bypass is formed in the gap between the maximum diameter of the conical 3DOS element and the inner diameter of the continuous pipe section.

15. The fluid decontamination apparatus according to claim 14, further comprising a fixture configured to hold the at least one 3DOS element within the continuous pipe section, said fixture comprising:
an outer frame having an outer diameter substantially equal to the inner diameter of the continuous pipe section; and
at least one radially-extending connection element configured to connect the outer frame to the at least one 3DOS element.

16. The fluid decontamination apparatus according to claim 1, wherein the at least one 3DOS element has a bicone shape having a first minimum diameter proximate to the nozzle, a maximum diameter downstream of the first diameter, and a second minimum diameter downstream of the maximum diameter.

17. The fluid decontamination apparatus as defined in claim 1, wherein the fluid flow is introduced within the continuous pipe section at pressures ranging from 0.2 MPa to 0.55 MPa for a water flow rate between 3.5 liters/min to 5.0 liters/min.

18. The fluid decontamination apparatus as defined in claim 1, wherein the 3DOS element is configured such that the hydrodynamic cavitation extended therein, resulting in localized pressure between 10 to 500 MPa and localized temperature between 1000 to 10,000K.

19. The fluid decontamination apparatus as defined in claim 1, wherein:
the continuous pipe section comprises of quartz material to enable a germicidal UV light disposed about the continuous pipe section to impinge UV irradiation onto the fluid flow; and
the at least one 3DOS element comprises of quartz material, to enable the germicidal UV light to impinge UV irradiation onto the fluid flow.
